(19) United States
(12) Patent Application Publication
(10) Pub. No.: US 2025/0202555 A1
(43) Pub. Date: Jun. 19, 2025

(54) CSI-RS RECEPTION FOR HIGH MOBILITY

(71) Applicant: Telefonaktiebolaget LM Ericsson (publ), Stockholm (SE)

(72) Inventors: Siva Muruganathan, Stittsville (CA); Mattias Frenne, Uppsala (SE); Shiwei Gao, Nepean (CA); Xinlin Zhang, Västra Frölunda (SE)

(21) Appl. No.: 18/836,226

(22) PCT Filed: Feb. 7, 2023
(86) PCT No.: PCT/IB2023/051088

§ 371 Date: Aug. 6, 2024

Related U.S. Application Data
(60) Provisional application No. 63/307,524, filed on Feb. 7, 2022.

(51) Int. Cl. H04B 7/06; H04L 5/00

(52) U.S. Cl. CPC H04B 7/0626; H04B 7/0639; H04L 5/0007

(57) ABSTRACT

Systems and methods are disclosed for Channel State Information (CSI) Reference Signal (RS) reception and associated CSI reporting. In one embodiment, a method performed by a User Equipment (UE) comprises receiving, from a network node, first information that provides a CSI-RS configuration with a plurality of CSI-RS samples at different time instances and receiving, from the network node, second information that configures the UE to report CSI feedback based on the CSI-RS configuration with the plurality of CSI-RS samples. The method further comprises computing at least one or more aspects of a precoding matrix for each CSI-RS sample of the plurality of CSI-RS samples, in accordance with the second information and reporting, to the network node, either the at least one or more aspects of the precoding matrix for each CSI-RS sample of the plurality of CSI-RS samples or information derived therefrom, via one or more CSI-RS reports.

### RELATED APPLICATIONS

This application claims the benefit of provisional patent application Ser. No. 63/307,524, filed Feb. 7, 2022, the disclosure of which is hereby incorporated herein by reference in its entirety.

### TECHNICAL FIELD

The present disclosure relates to a cellular communications system and, more specifically, to Channel State Information Reference Signal (CSI-RS) in a Radio Access Network (RAN) of a cellular communications system.

### BACKGROUND

### Multi-User Multiple-Input Multiple-Output (MU-MIMO)

With MU-MIMO, two or more User Equipments (UEs) in the same cell are co-scheduled on the same time-frequency resource(s). That is, two or more independent data streams are transmitted to different UEs at the same time, and the spatial domain can typically be used to separate the respective streams. By transmitting several streams simultaneously, the capacity of the system can be increased. This, however, comes at the cost of reducing the Signal to Interference plus Noise Ratio (SINR) per stream, as the power must be shared between streams and the streams will cause interference to each-other.

### Channel State Information Reference Signal (CSI-RS)

For Channel State Information (CSI) measurement and feedback, CSI-RS are defined. A CSI-RS is transmitted on each antenna port and is used by a UE to measure the downlink channel between each of the transmit antenna ports and each of its receive antenna ports. The transmit antenna ports are also referred to as CSI-RS ports. The supported number of antenna ports in Third Generation Partnership Project (3GPP) New Radio (NR) are currently {1,2,4,8,12,16,24,32}. By measuring the received CSI-RS, a UE can estimate the channel that the CSI-RS is traversing, including the radio propagation channel and antenna gains. The CSI-RS for the above purpose is also referred to as Non-Zero Power (NZP) CSI-RS.

CSI-RS can be configured to be transmitted in certain Resource Elements (REs) in a slot and certain slots. FIG. 1 shows an example of CSI-RS REs for twelve (12) antenna ports, where 1 RE per Resource Block (RB) per port is shown.

FIG. 1 illustrates an example of RE allocation for a 12-port CSI-RS in NR.

In addition, Interference Measurement Resource (IMR) is defined in NR for a UE to measure interference. An IMR resource contains 4 Res, either 4 adjacent Res in frequency in the same Orthogonal Frequency Division Multiplexing (OFDM) symbol or 2 by 2 adjacent Res in both time and frequency in a slot. By measuring both the channel based on NZP CSI-RS and the interference based on an IMR, a UE can estimate the effective channel and noise plus interference to determine the CSI, i.e., rank, precoding matrix, and channel quality.

Furthermore, a UE in NR may be configured to measure interference based on one or multiple NZP CSI-RS resource.

### Tracking Reference Signal (TRS)

Due to oscillator imperfections, transmission and reception may not be synchronized in time and/or frequency, which can cause inter- and intra-symbol interference. In NR, TRS was introduced that can be used by the UE for synchronization.

In NR 3GPP specifications, TRS can be configured when CSI report setting is not configured or when the higher layer parameter ‘reportQuantity’ in the CSI-ReportConfig Information Element (IE), associated with all the report settings linked with the CSI-RS resource set containing the TRS(s) is set to ‘none’. This means that CSI reporting based in measurements on TRS is not supported in NR.

TRS is configured via ‘trs-Info’ in the NZP-CSI-RS-ResourceSet IE of 3GPP Technical Specification (TS) 38.331 V16.6.0 which is associated with a CSI-RS resource set, for which the UE can assume that the antenna port with the same port index of the configured NZP CSI-RS resources in the said resource set is the same. From 3GPP specifications perspective, TRS is specified as a special kind of NZP CSI-RS where the corresponding NZP CSI-RS resource set containing the TRS(s) has a higher layer parameter ‘trs-info’ set to true.

TRS is not really a CSI-RS, rather it is a resource set consisting of multiple periodic NZP CSI-RS. More specifically, a TRS consists of four one-port, density-3 CSI-RSs located within two consecutive slots. The CSI-RS within the resource set can be configured with a periodicity of 10, 20, 40, or 80 milliseconds (ms). Note that the exact set of Res used for the TRS CSI-RS may vary. There is always a four-symbol time-domain separation between the two CSI-RS within a slot. FIG. 2 shows an example of a TRS burst of two TRS symbols in two adjacent slots.

NR also supports aperiodic TRS.

For LTE, the Cell-Specific Reference Signal (CRS) served the same purpose as the TRS as LTE CRS can be used for synchronization but it can also be used for CSI reporting, which is not supported for TRS in NR. However, compared to the LTE CRS, the TRS implies much less overhead, only having one antenna port and only being present in two slots every TRS period.

### CSI Framework in NR

In NR, a UE can be configured with multiple CSI reporting settings (also known as CSI-ReportConfig in 3GPP TS 38.331 V16.6.0) and multiple CSI-RS resource settings. Each CSI-RS resource setting can contain multiple resource sets, and each resource set can contain up to eight CSI-RS resources. For each CSI reporting setting, a UE feeds back a CSI report.

Each CSI reporting setting contains at least the following information:
A CSI-RS resource set for channel measurement.
An IMR resource set for interference measurement
Optionally, a CSI-RS resource set for interference measurement
Time-domain behavior, i.e., periodic, semi-persistent, or aperiodic reporting
Frequency granularity, i.e., wideband or subband
CSI parameters to be reported such as Rank Indicator (RI), Precoding Matrix Indicator (PMI), Channel Quality Indicator (CQI), and CSI-RS Resource Indicator (CRI) in case of multiple CSI-RS resources in a resource set
Codebook types, i.e., Type I or II, and codebook subset restriction
Measurement restriction
Subband size. One out of two possible subband sizes is indicated, the value range depends on the bandwidth of the Bandwidth Part (BWP). One CQI/PMI (if configured for subband reporting) is fed back per subband.

### Type I and Type II Codebooks in NR

Type I codebook (CB) is typically used by a UE to report CSI for Single User Multiple-Input Multiple-Output (SU-MIMO) scheduling in NR. While type II CB is typically for more accurate CSI feedback for MU-MIMO scheduling.

For both type I and type II CBS, for each rank, a precoding matrix W is defined in the form of

$$W = {W}_{1} {W}_{2}$$

$$where {W}_{1} = [ \begin{matrix}{d}_{1} & {d}_{2} & … & {d}_{L} & 0 & 0 & … & 0 \\ 0 & 0 & … & 0 & {d}_{1} & {d}_{2} & … & {d}_{L}\end{matrix} ]$$

is a 2Nx2L matrix and contains information of L selected Discrete Fourier Transform (DFT) beams {dᵢ, i=1, . . . , L}, where dᵢ is a Nx1 DFT vector and N is the number of CSI-RS ports per polarization; while W₂ is a 2L×ν matrix and contains the co-phasing coefficients between the selected beams and also between antenna ports with two different polarizations, where ν is the number of layers or rank. W₁ is the same for the whole CSI bandwidth, while W₂ can be for the whole bandwidth or per subband.

In case of type I CB, the precoding vector for each MIMO layer is associated with a single DFT beam. While for type II CB, the precoding vector for each layer is a linear combination of multiple DFT beams.

### Enhanced Type II Codebook in NR

In NR Rel-16, type II CB is enhanced by applying Frequency Domain (FD) DFT basis across all subbands to reduced CSI feedback overhead and/or improve CSI accuracy. Instead of reporting W₂ for each subband, linear combinations of DFT basis vectors are used to jointly represent W₂ across the whole CSI bandwidth. For each layer, a precoding matrix W across all subbands is in the form of

W=\tilde{W}₁\tilde{W}₂W_{f}^{H}

where W_{f}= [f₁, . . . , fₘ] is a matrix containing M selected DFT basis vectors {f₁, . . . , fₘ}, W₂ is 2L×M matrix containing the co-phasing coefficients for each selected DFT beam and each selected FD basis vector, and W₁ contains the selected DFT beams (i.e., in spatial domain.

### QCL

Several signals can be transmitted from different antenna ports of a same base station. These signals can have the same large-scale properties such as Doppler shift/spread, average delay spread, or average delay. These antenna ports are then said to be Quasi Co-Located (QCL).

If the UE knows that two antenna ports are QCL with respect to a certain parameter (e.g., Doppler spread), the UE can estimate that parameter based on one of the antenna ports and apply that estimate for receiving signal on the other antenna port. Typically, the first antenna port is represented by a measurement reference signal such as TRS or Synchronization Signal Block (SSB) (known as source Reference Signal (RS)) and the second antenna port is a Demodulation Reference Signal (DMRS) (known as target RS).

For instance, if antenna ports A and B are QCL with respect to average delay, the UE can estimate the average delay from the signal received from antenna port A and assume that the signal received from antenna port B has the same average delay. This is useful for demodulation since the UE can know beforehand the properties of the channel, which for instance helps the UE in selecting an appropriate channel estimation filter.

Information about what assumptions can be made regarding QCL is signaled to the UE from the network. In NR, four types of QCL relations between a transmitted source RS and transmitted target RS were defined:
Type A: {Doppler shift, Doppler spread, average delay, delay spread}
Type B: {Doppler shift, Doppler spread}
Type C: {average delay, Doppler shift}
Type D: {Spatial Rx parameter}
   Beam Management with Unified TCI Framework

In NR, downlink beam management is performed by conveying spatial QCL (‘Type D’) assumptions to the UE through Transmission Configuration Indicator (TCI) states.

In NR Rel-15 or Rel-16, for Physical Downlink Control Channel (PDCCH), the network (NW) configures the UE with a set of PDCCH TCI states by Radio Resource Control (RRC), and then activates one TCI state per Control Resource Set (CORESET) using Medium Access Control (MAC) Control Element (CE). For Physical Downlink Shared Channel (PDSCH) beam management, the NW configures the UE with a set of PDSCH TCI states by RRC, and then activates up to 8 TCI states by MAC CE. After activation, the NW dynamically indicates one of these activated TCI states using a TCI field in Downlink Control Information (DCI) when scheduling PDSCH.

Such a framework allows great flexibility for the network to instruct the UE to receive signals from different spatial directions in the downlink with a cost of large signaling overhead and slow beam switch. These limitations are particularly noticeable and costly when UE movement is considered. One example is that beam update using DCI can only be performed for PDSCH, and MAC CE and/or RRC is required to update the beam for other reference signals/channels, with causes extra overhead and latency.

Furthermore, in majority of cases, the network transmits to and receives from a UE in the same direction for both data and control. Hence, using separate frameworks (TCI state respective spatial relations) for different channels/signals complicates the implementations.

In Rel-17, a common beam framework was introduced to simplify beam management in Frequency Range 2(FR2), in which a common beam represented by a TCI state may be activated/indicated to a UE and the common beam is applicable for multiple channels/signals such as PDCCH and PDSCH. The common beam framework is also referred to a unified TCI state framework.

The new framework can be RRC configured in one out two modes of operation, i.e., “Joint DL/UL TCI” or “Separate DL/UL TCI”. For “Joint DL/UL TCI”, one common Joint TCI state is used for both downlink (DL) and uplink (UL) signals/channels. For “Separate DL/UL TCI”, one common DL-only TCI state is used for DL channels/signals and one common UL-only TCI state is used for UL signals/channels.

A unified TCI state can be updated in a similar way as the TCI state update for PDSCH in Rel-15/16, i.e., with one of two alternatives:
Two-stage: RRC signaling is used to configure a number of unified TCI states in higher layer parameter PDSCH-config, and a MAC CE is used to activate one of unified TCI states, or
Three-stage: RRC signaling is used to configure a number of unified TCI states in PDSCH-config, a MAC CE is used to activate up to 8 unified TCI states, and a 3-bit TCI state bitfield in DCI is used to indicate one of the activate unified TCI states.

The one activated or indicated unified TCI state will be used in subsequent PDCCH and PDSCH transmissions until a new unified TCI state is activated or indicated.

The existing DCI formats 1_1 and 1_2 are reused for beam indication, both with and without DL assignment. For DCI formats 1_1 and 1_2 with DL assignment, Acknowledgment (ACK)/Negative Acknowledgment (NACK) of the PDSCH can be used as indication of successful reception of beam indication. For DCI formats 1_1 and 1_2 without DL assignment, a new ACK/NACK mechanism analogous to that for Semi-Persistent Scheduling (SPS) PDSCH release with both type-1 and type-2 HARQ-ACK codebook is used, where upon a successful reception of the beam indication DCI, the UE reports an ACK.

For DCI-based beam indication, the first slot to apply the indicated TCI state is at least Y symbols after the last symbol of the acknowledgment of the joint or separate DL/UL beam indication. The Y symbols are configured by the next generation Node B (gNB) based on UE capability, which is also reported in units of symbols. The values of Y are yet not determined and is left to RAN4 to decide.

### SUMMARY

Systems and methods are disclosed for Channel State Information (CSI) Reference Signal (RS) reception and associated CSI reporting. In one embodiment, a method performed by a User Equipment (UE) comprises receiving, from a network node, first information that provides a CSI-RS configuration with a plurality of CSI-RS samples at different time instances and receiving, from the network node, second information that configures the UE (312) to report CSI feedback based on the CSI-RS configuration with the plurality of CSI-RS samples. The method further comprises computing at least one or more aspects of a precoding matrix for each CSI-RS sample of the plurality of CSI-RS samples, in accordance with the second information and reporting, to the network node, either the at least one or more aspects of the precoding matrix for each CSI-RS sample of the plurality of CSI-RS samples or information derived therefrom, via one or more CSI-RS reports. In this manner, performance under mobility scenarios can be improved.

In one embodiment, the plurality of CSI-RS samples are at different time instances within a single timeslot.

In one embodiment, the plurality of CSI-RS samples are at different time instances, the different time instances comprise at least one time instance in a first timeslot and at least one time instance in a second timeslot that is different than the first timeslot.

In one embodiment, the different times instances are either: different Orthogonal Frequency Division Multiplexing (OFDM) symbols within a single timeslot, or a same OFDM symbol in different timeslots, or different OFDM symbols in different timeslots.

In one embodiment, the first information comprises information that configures the plurality of CSI-RS samples as different Non-Zero Power (NZP) CSI-RS resources in a NZP CSI-RS resource set. In another embodiment, the first information comprises information that configures a plurality of NZP CSI-RS resources in a NZP CSI-RS resource set and a parameter that indicates that the plurality of NZP CSI-RS resources in the NZP CSI-RS resource set are to be interpreted by the UE as the plurality of CSI-RS samples of a same NZP CSI-RS. In one embodiment, the plurality of CSI-RS samples are aperiodic. In one embodiment, the plurality of CSI-RS samples are triggered by a single trigger. In one embodiment, the number of CSI-RS samples in the plurality of CSI-RS samples is equal to the number of NZP CSI-RS resources in the NZP CSI-RS resource set.

In one embodiment, the first information further comprises information that explicitly or implicitly indicates a number of CSI-RS samples in the plurality of CSI-RS samples. In one embodiment, CSI-RS resource mappings for at least some of the plurality of NZP CSI-RS resources in the NZP CSI-RS resource set are different. In one embodiment, time-domain locations configured for at least some of the plurality of NZP CSI-RS resources in the NZP CSI-RS resource set are different. In one embodiment, the first information further comprises one or more common parameters that are common to all of the plurality of NZP CSI-RS resources in the NZP CSI-RS resource set.

In one embodiment, all of the plurality of NZP CSI-RS resources in the NZP CSI-RS resource set have a same number M of antenna ports. In one embodiment, the m^{th}(m=0,1, . . . , M−1) antenna port for all of the plurality of NZP CSI-RS resources in the NZP CSI-RS resource set is the same.

In one embodiment, at least two of the plurality of NZP CSI-RS resources in the NZP CSI-RS resource set have different numbers of antenna ports.

In one embodiment, one NZP CSI-RS resource of the plurality of NZP CSI-RS resources in the NZP CSI-RS resource set has a first number of antenna ports and all remaining NZP CSI-RS resources of the plurality of NZP CSI-RS resources in the NZP CSI-RS resource set have a second number of antenna ports. In one embodiment, the second number of antenna ports is less than the first number of antenna ports. In another embodiment, the second number of antenna ports are associated with only a single polarization.

In one embodiment, the plurality of NZP CSI resources in the NZP CSI-RS resource set are periodic, and a same Transmission Configuration Indication (TCI) state identity (ID) is configured for all of the plurality of NZP-CSI resources in the NZP CSI-RS resource set.

In one embodiment, the plurality of NZP CSI resources in the NZP CSI-RS resource set are periodic, and a single parameter that indicates a TCI state identity ID configured for one of the plurality of NZP-CSI resources in the NZP CSI-RS resource set and is applicable to all of the plurality of NZP-CSI resources in the NZP CSI-RS resource set.

In one embodiment, the plurality of NZP CSI resources in the NZP CSI-RS resource set are periodic, and a single parameter that indicates a TCI state ID configured for all of the plurality of NZP CSI resources in the NZP CSI-RS resource set is comprised in an information element that defines the NZP CSI-RS resource set.

In one embodiment, the plurality of NZP-CSI resources in the NZP CSI-RS resource set are semi-persistent, and a same TCI state ID is configured for all of the plurality of NZP CSI resources in the NZP CSI-RS resource set via a Medium Access Control (MAC) Control Element (CE) that activates the NZP CSI-RS resource set.

In one embodiment, the plurality of NZP-CSI resources in the NZP CSI-RS resource set are semi-persistent, and a single TCI state ID is configured and applicable to of the plurality of NZP CSI resources in the NZP CSI-RS resource set via a MAC CE that activates the NZP CSI-RS resource set.

In one embodiment, the plurality of NZP CSI resources in the NZP CSI-RS resource set are semi-persistent, and a single parameter that indicates a TCI state ID configured for all of the plurality of NZP CSI resources in the NZP CSI-RS resource set is comprised in an information element that defines the NZP CSI-RS resource set.

In one embodiment, the plurality of NZP CSI resources in the NZP CSI-RS resource set are aperiodic, and a same TCI state ID is configured for all of the plurality of NZP CSI resources in the NZP CSI-RS resource set.

In one embodiment, the plurality of NZP CSI resources in the NZP CSI-RS resource set are aperiodic, and a single TCI state ID is configured for all of the plurality of NZ-CSI resources in the NZP CSI-RS resource set via an information element that defines the NZP CSI-RS resource set.

In one embodiment, a unified TCI state currently activated to the UE is applied to all of the plurality of NZP CSI resources in the NZP CSI-RS resource set.

In one embodiment, the first information comprises information that configures the plurality of CSI-RS samples via a configuration of a single NZP CSI-RS resource and information that defines a plurality of repetitions of the NZP CSI-RS resource which correspond to the plurality of CSI-RS samples. In one embodiment, the information that defines the plurality of repetitions of the NZP CSI-RS resource comprises information indicates one or more time offsets between repetitions of the NZP CSI-RS resource. In one embodiment, the plurality of repetitions of the NZP CSI-RS resource are within a single timeslot. In another embodiment, at least one first repetition of the plurality of repetitions of the NZP CSI-RS resource is within a first timeslot and at least one second repetition of the plurality of repetitions of the NZP CSI-RS resource is within a second timeslot.

In one embodiment, the CSI feedback is Type I CSI feedback, and, for each CSI-RS sample of the plurality of CSI-RS samples, the at least one or more aspects of the precoding matrix reported to the network node comprises a set of cophasing coefficients (W₂).

In one embodiment, the CSI feedback is Type I CSI feedback, and the at least one or more aspects of the precoding matrix reported to the network node comprises a set of cophasing coefficient (W₂) for one CSI-RS sample of the plurality of

CSI-RS samples, and, for each remaining CSI-RS sample of the plurality of CSI-RS samples, the at least one or more aspects of the precoding matrix reported to the network node comprises a phase difference of each coefficient of W₂ for the remaining CSI-RS sample and a respective coefficient of W₂ for the one CSI-RS sample. In one embodiment, for at least one CSI-RS sample of the plurality of CSI-RS samples, the at least one or more aspects of the precoding matrix reported to the network node comprises a matrix (W₁) that contains information of one or more selected Discrete Fourier Transform (DFT) beams.

In one embodiment, the CSI feedback is Type II CSI feedback, and, for each CSI-RS sample of the plurality of CSI-RS samples, the at least one or more aspects of the precoding matrix reported to the network node comprises a set of cophasing coefficient (W₂) and a selected set of Frequency Domain (FD) basis vectors.

In one embodiment, the CSI feedback is Type II CSI feedback. For one CSI-RS sample of the plurality of CSI-RS samples, the at least one or more aspects of the precoding matrix reported to the network node comprises a set of cophasing coefficient (W₂) and a selected set of FD, basis vectors. For each remaining CSI-RS sample of the plurality of CSI-RS samples, the at least one or more aspects of the precoding matrix reported to the network node comprises a phase difference of each coefficient of W₂ for the remaining CSI-RS sample and a respective coefficient of W₂ for the one CSI-RS sample and a selected set of FD basis vectors. In one embodiment, for at least one CSI-RS sample of the plurality of CSI-RS samples, the at least one or more aspects of the precoding matrix reported to the network node comprises a matrix (W₁) that contains information of one or more selected DFT beams.

Corresponding embodiments of a UE are also disclosed. In one embodiment, a UE comprises one or more transmitters, one or more receivers, and processing circuitry associated with the one or more transmitters and the one or more receivers. The processing circuitry is configured to cause the UE to receive, from a network node, first information that provides a CSI-RS configuration with a plurality of CSI-RS samples at different time instances, receive, from the network node, second information that configures the UE to report CSI feedback based on the CSI-RS configuration with the plurality of CSI-RS samples, compute at least one or more aspects of a precoding matrix for each CSI-RS sample of the plurality of CSI-RS samples, in accordance with the second information, and report, to the network node, either the at least one or more aspects of the precoding matrix for each CSI-RS sample of the plurality of CSI-RS samples or information derived therefrom, via one or more CSI-RS reports.

Embodiments of a method performed by a network node are also disclosed. In one embodiment, a method performed by a network comprises sending, to a UE, first information that provides a CSI-RS configuration with a plurality of CSI-RS samples at different time instances, sending, to the UE, second information that configures the UE to report CSI feedback based on the CSI-RS configuration with the plurality of CSI-RS samples at different times instances, and receiving, from the UE, either at least one or more aspects of the precoding matrix for each CSI-RS sample of the plurality of CSI-RS samples or information derived therefrom, via one or more CSI-RS reports.

Corresponding embodiments of a network node are also disclosed. In one embodiment, a network comprises processing circuitry configured to cause the network node to send, to a UE, first information that provides a CSI-RS configuration with a plurality of CSI-RS samples at different time instances, send, to the UE, second information that configures the UE to report CSI feedback based on the CSI-RS configuration with the plurality of CSI-RS samples at different times instances, and receive, from the UE, either at least one or more aspects of the precoding matrix for each CSI-RS sample of the plurality of CSI-RS samples or information derived therefrom, via one or more CSI-RS reports.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 shows an example of Channel State Information Reference Signal (CSI-RS) Resource Elements (Res) for twelve (12) antenna ports, where 1 RE per Resource Block (RB) per port is shown;

FIG. 2 shows an example of a Tracking Reference Signal (TRS) burst of two

TRS symbols in two adjacent slots;

FIG. 3 illustrates one example of a cellular communications system in which embodiments of the present disclosure may be implemented;

FIG. 4 shows an example CSI-RS configuration with multiple (e.g., 3) samples in different time instances t₁, t₂, and t₃, in accordance with one example embodiment of the present disclosure;

FIG. 5 shows an example phase slot for a coefficient of co-phasing coefficient matrix W₂(t) component of a precoding matrix W for Type I and Type II codebooks is illustrated in FIG. 5;

FIG. 6 shows an example phase slot for a coefficient of W₂(t);

FIG. 7 illustrates an example of configuring multi-sample CSI-RS as part of Non-Zero Power (NZP) CSI-RS Resource set, in accordance with one embodiment of the present disclosure;

FIG. 8 shows an example where three 8-port NZP CSI-RS resources in a NZP CSI-RS resource set are configured as multiple samples of the same NZP CSI-RS, in accordance with one embodiment of the present disclosure;

FIG. 9 shows an example where one 8-port NZP CSI-RS resource and two 4-port NZP CSI-RS resources in a NZP CSI-RS resource set are configured as multiple samples of the same NZP CSI-RS, in accordance with one embodiment of the present disclosure;

FIG. 10 shows an example embodiment in which, when the NZP CSI-RS resources are periodic, the parameter qcl-InfoPeriodicCSI-RS-r18 which provides the TCI State ID for the NZP CSI-RS resources in the NZP CSI-RS resource set is configured in the NZP-CSI-RS-ResourceSet Information Element (IE);

FIG. 11 illustrates an example embodiment where the parameter qcl-info-r18, which contains a single Transmission Configuration Indication (TCI) state Identity (ID), provides the TCI state to be applied to all the aperiodic NZP CSI-RS resources in the NZP CSI-RS resource set;

FIG. 12 illustrates an example embodiment where eight ports CSI-RS resource is repeated two times in a slot with a gap of three Orthogonal Frequency Division Multiplexing (OFDM) symbols;

FIG. 13 illustrates an example embodiment where a 32-ports CSI-RS resource is repeated in two consecutive slots;

FIGS. 14A and 14B illustrate the operation of a network node and a User Equipment (UE) in accordance with at least some embodiments of the present disclosure;

FIGS. 15, 16, and 17 are schematic block diagrams of example embodiments of a radio access node;

FIGS. 18 and 19 are schematic block diagrams of example embodiments of a UE;

FIG. 20 illustrates an example of a communication system in which embodiments of the present disclosure may be implemented;

FIG. 21 illustrates example embodiments of the host computer, base station, and UE of FIG. 20; and

FIGS. 22, 23, 24, and 25 are flow charts that illustrate the operation of nodes of the communication system of FIGS. 20 and 21 in accordance with embodiments of the present disclosure.

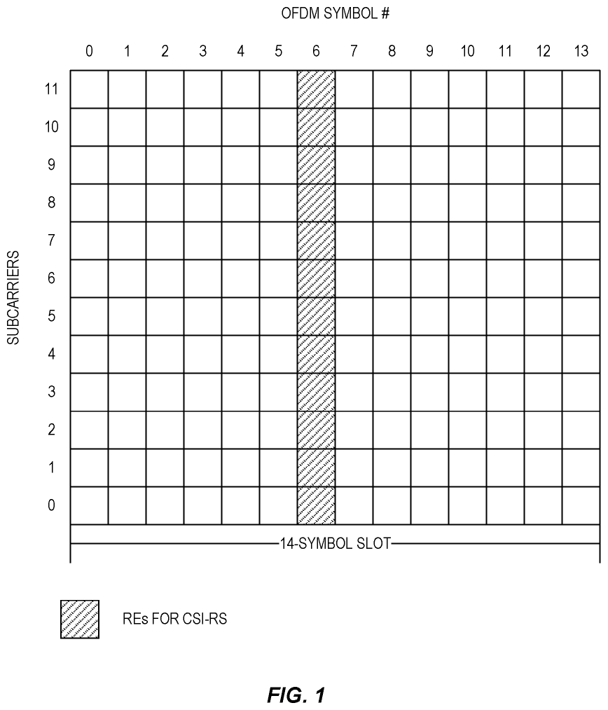

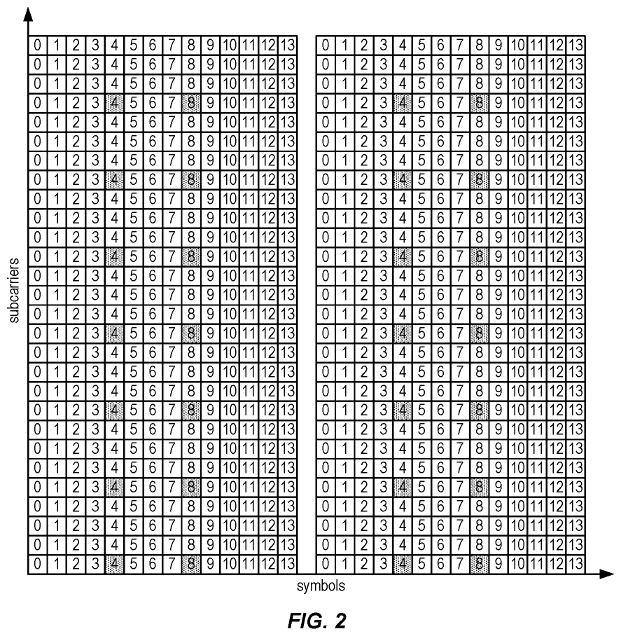

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

In some embodiments, a set Transmission Points (TPs) is a set of geographically co-located transmit antennas (e.g., an antenna array (with one or more antenna elements)) for one cell, part of one cell or one Positioning Reference Signal (PRS)-only TP. TPs can include base station (eNB) antennas, Remote Radio Heads (RRHs), a remote antenna of a base station, an antenna of a PRS-only TP, etc. One cell can be formed by one or multiple TPs. For a homogeneous deployment, each TP may correspond to one cell.

In some embodiments, a set of TRPs is a set of geographically co-located antennas (e.g., an antenna array (with one or more antenna elements)) supporting TP and/or Reception Point (RP) functionality.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). It is observed by measurements in real deployments that downlink Multi-User Multiple-Input Multiple-Output (MU-MIMO) precoding performance degrades when one or more of the co-scheduled UEs start to move faster than a few kilometers (km) per hour (km/h) relative to the base station. One of the main reasons is that the information of the channels, which is used to compute the Multiple-Input Multiple-Output (MIMO) precoding at the base station, becomes outdated rather quickly when this occurs. As a result, the precoder loses its effectiveness to protect co-scheduled UEs from interference when transmitting to an intended UE. Hence, downlink MU-MIMO precoding needs to be made robust to higher UE speeds.

It has been proposed and discussed in 3GPP pre-Release 18 scoping to extend Type-I or Type-II Channel State Information (CSI) feedback with time domain/Doppler information. However, the current CSI Reference Signal (CSI-RS) configuration is not suitable for deriving time domain/Doppler information as only a single CSI-RS sample is configured per resource within a CSI-RS periodicity in the current CSI-RS resource configuration. In order for the UE to compute time domain/Doppler information and feed it back as an extension of Type-I or Type-II CSI feedback, CSI-RS resource configuration with multiple samples is needed. How to configure the UE with such multiple sample CSI-RS is an open problem that needs to be solved.

Certain aspects of the present disclosure and their embodiments may provide solutions to the aforementioned or other challenges. Embodiments relating to two different alternative solutions are proposed for configuring multiple Non-Zero Power (NZP) CSI-RS samples. These solutions include the following solutions.
A first solution (Solution 1) is based on configuring multiple NZP CSI-RS resources within a NZP CSI-RS resource set wherein each of the multiple NZP CSI-RS resources represents a single sample
A second solution (Solution 2) is based on configuring a single NZP CSI-RS resource and configurating a repetition number associated with the single NZP CSI-RS resource.

For Solution 1, embodiment of systems and methods are provided for configuring multiple NZP CSI-RS samples via configuring multiple NZP CSI-RS resources in a NZP CSI-RS resource set where each of the multiple NZP CSI-RS resources represents one NZP CSI-RS sample. These embodiments may include any one or more of the following aspects:
Details on how to configure the NZP CSI-RS resource set to contain multiple samples of NZP CSI-RS (this is to be differentiated from legacy operation where different NZP CSI-RS resources in the NZP CSI-RS resource set are different NZP CSI-RSs)-see section 3 for different ways of configuring the NZP CSI-RS resource set for multi-sample NZP CSI-RS.
Assumption on antenna ports in different NZP CSI-RS resources in the NZP CSI-RS resource set-See details in section 3.1.
Details of TCI state indication for the different NZP CSI-RS resources in the NZP CSI-RS resource set
   see Section 3.2 for details related to Periodic NZP CSI-RS
   see Section 3.3 for details related to semi-persistent NZP CSI-RS see Section 3.4 for details related to aperiodic NZP CSI-RS
   see Section 3.5 for details on TCI state indication via unified TCI framework
Performing CSI measurement and reporting on multiple samples of NZP CSI-RS-see Section 1 or 2.

For Solution 2, embodiments of systems and methods are provided for configuring multiple NZP CSI-RS samples via configuring a single NZP CSI-RS resource, wherein a number of repetitions is associated with the single NZP CSI-RS resource and each repetition represents a single NZP CSI-RS sample. These embodiments may include one or more of the following aspects:
Details of intra-slot NZP CSI-RS repetition-See Section 4.1.
Details of inter-slot NZP CSI-RS repetition-See Section 4.2.
Performing CSI measurement and reporting on multiple samples of NZP CSI-RS-see Section 1 or 2.

Certain embodiments may provide one or more of the following technical advantage(s). Embodiments of the proposed solutions enable CSI measurements on multiple NZP CSI-RS samples, e.g., to improve performance under mobility scenarios. Some of the embodiments provide specific ways of configuring multiple NZP CSI-RS samples with reduced configuration overhead (e.g., reduced Radio Resource Control (RRC) signaling overhead).

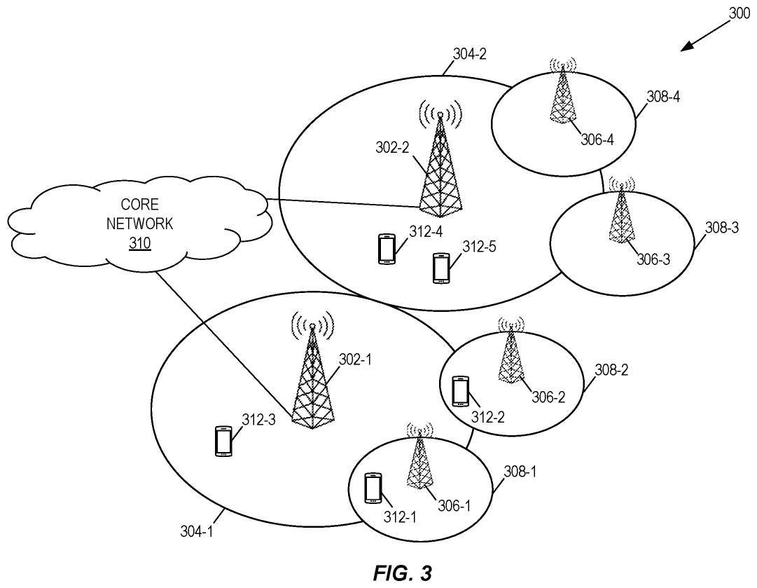

FIG. 3 illustrates one example of a cellular communications system 300 in which embodiments of the present disclosure may be implemented. In the embodiments described herein, the cellular communications system 300 is a 5G system (5GS) including a Next Generation RAN (NG-RAN) and a 5G Core (5GC); however, the present disclosure is not limited thereto and may be utilized in other types of wireless or cellular communications system such as, e.g., an Evolved Packet System (EPS) including an Evolved Universal Terrestrial RAN (E-UTRAN) and an Evolved Packet Core (EPC). In this example, the RAN includes base stations 302-1 and 302-2, which in the 5GS include NR base stations (gNBs) and optionally next generation eNBs (ng-eNBs) (e.g., LTE RAN nodes connected to the 5GC), controlling corresponding (macro) cells 304-1 and 304-2. The base stations 302-1 and 302-2 are generally referred to herein collectively as base stations 302 and individually as base station 302. Likewise, the (macro) cells 304-1 and 304-2 are generally referred to herein collectively as (macro) cells 304 and individually as (macro) cell 304. The RAN may also include a number of low power nodes 306-1 through 306-4 controlling corresponding small cells 308-1 through 308-4. The low power nodes 306-1 through 306-4 can be small base stations (such as pico or femto base stations) or RRHs, or the like. Notably, while not illustrated, one or more of the small cells 308-1 through 308-4 may alternatively be provided by the base stations 302. The low power nodes 306-1 through 306-4 are generally referred to herein collectively as low power nodes 306 and individually as low power node 306. Likewise, the small cells 308-1 through 308-4 are generally referred to herein collectively as small cells 308 and individually as small cell 308. The cellular communications system 300 also includes a core network 310, which in the 5G System (5GS) is referred to as the 5GC. The base stations 302 (and optionally the low power nodes 306) are connected to the core network 310.

The base stations 302 and the low power nodes 306 provide service to wireless communication devices 312-1 through 312-5 in the corresponding cells 304 and 308. The wireless communication devices 312-1 through 312-5 are generally referred to herein collectively as wireless communication devices 312 and individually as wireless communication device 312. In the following description, the wireless communication devices 312 are oftentimes UEs, but the present disclosure is not limited thereto.

A description of embodiments of how multiple CSI-RS samples are used by the UE 312 to extend Type-I or Type-II codebook based CSI feedback with time domain/Doppler information is first provided. This is followed by detailed embodiments for configuring and signaling of CSI-RS with multiple samples.

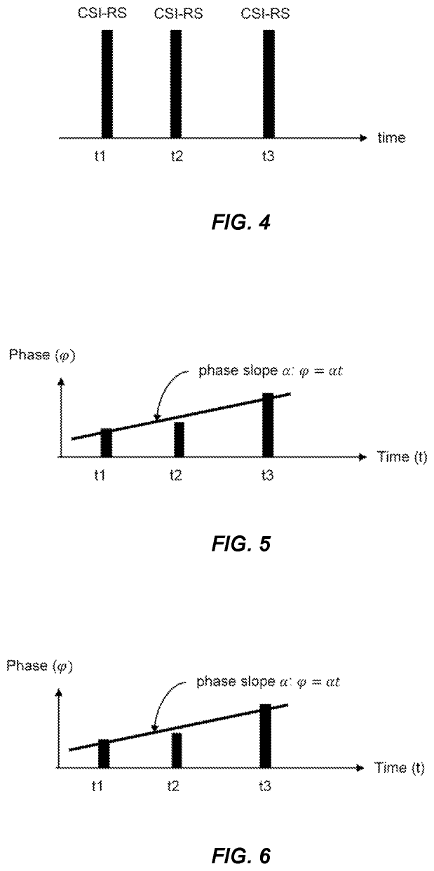

FIG. 4 shows an example CSI-RS configuration with multiple (e.g., 3) samples in different time instances t₁, t₂, and t₃. The different time instances may be in different Orthogonal Frequency Division Multiplexing (OFDM) symbols within a same slot, or in the same or different OFDM symbols in different slots. In some embodiments, the time instances may be non-uniformly spaced (for example, t₂−t₁=2 and t₃−t₂=3). Note that the multiple time instances or samples can be within a CSI-RS periodicity in case the CSI-RS is configured as periodic or semi-persistent CSI-RS. In case the CSI-RS is configured as aperiodic CSI-RS, then the multiple time instances or samples are triggered by a single trigger (e.g., triggered via a single DCI).

### 1 Type I CSI Feedback Extension Based on Multiple CSI-RS Samples

First, let us assume that the UE 312 is configured for Type I CSI feedback based on the CSI-RS configuration with multiple samples. For each time instance, the UE 312 may compute the type I precoding matrix as

W(t)=W₁(t)W₂(t),t∈{t₁,t₂,t₃}

Note that the selected Discrete Fourier Transform (DFT) beams change slowly when the time difference t₃-t₁ is small, i.e., W₁(t₁)≈W₁(t₂)≈W₁(t₃). Thus, in some embodiments, it is sufficient to compute and report one of W₁(t₁) and there is no need to compute and report W₁(t₂) and W₁(t₃). Stated in other words, for computing and reporting the selected DFT beams for Type I CSI feedback, it is sufficient to compute the selected DFT beams on one of the multiple samples of the CSI-RS (e.g., compute W₁(t₁) on t₁ and report W₁(t₁)). However, as the co-phasing coefficients between selected beams change with different time instances, W₂ needs to be computed and reported at each instance t₁, t₂, and t₃(i.e., W₂(t₁), W₂(t₂), and W₂(t₃) computed at times t₁, t₂, and t₃).

In one embodiment, W₁(t₁) and W₂(t₁) are reported in one reporting instance, while W₂(t₂) and W₂(t₃) are reported in separate reporting instances.

In another embodiment, W₁(t₁) and W₂(t₁) are reported in a first reporting instance, while W₂(t₂) and W₂(t₃) are jointly reported in a second reporting instances.

In yet another embodiment, W₁(t₁), W₂(t₁), W₂(t₂) and W₂(t₃) are reported jointly in a single reporting instance.

In the above embodiments, the reporting instances may be reported via either PUSCH or PUCCH.

In one example, with W₂(t₁), W₂(t₂), and W₂(t₃), the network (e.g., a network node such as a base station 302, e.g., a gNB) can derive the phase change for each W₂ coefficient over time instances {t₁, t₂, t₃} and thus estimate the underlying corresponding Doppler frequency or phase slope over the time period based on some criteria such as mean square error (MSE). An example phase slot for a coefficient of W₂(t) is illustrated in FIG. 5. The estimated Doppler frequency or phase slope can then be used to predict the corresponding W₂ coefficient in a future time instance.

Alternatively, instead of reporting W₂(t₂) and W₂(t₃), the phase difference of each coefficient of W₂ in different time instances with respect to the first time instance are reported. In a further embodiment, the phase slope of each coefficient of W₂ over the time window is reported.

### 2 Type II CSI Feedback Extension Based on Multiple CSI-RS Samples

Now, let us assume that the UE 312 is configured for Type II CSI feedback based on the CSI-RS configuration with multiple samples. For each time instance, the UE 312 may compute the type II precoding matrix for each MIMO layer as

W(t)=W₁(t)W₂(t)W_{f}^{H}(t),t∈{t₁,t₂,t₃}

Note that the selected DFT beams (i.e., in spatial domain) in W₁(t) and the selected Frequency Domain (FD) basis vectors in W_{f}(t) change slowly when the time difference t₃-t₁ is small, i.e., W₁(t₁)≈W₁(t₂)≈W₁(t₃), and W_{f}(t₁)≈W_{f}(t₂)≈W_{f}(t₃). Thus, in some embodiments, it is sufficient to compute and report W₁(t₁) and there is no need to compute and report W₁(t₂) and W₁(t₃). Stated in other words, for computing and reporting the selected DFT beams (i.e., in spatial domain) for Type II CSI feedback, it is sufficient to compute the selected DFT beams on the one of the multiple samples of the CSI-RS (e.g., compute W₁(t₁) on t₁ and report W₁(t₁)). Similarly, it is sufficient to compute and report W_{f}(t₁), and the UE 312 does not need to compute nor report W_{f}(t₂) and W_{f}(t₃). That is, for computing and reporting the selected FD basis vectors for enhanced type II CSI feedback, it is sufficient to compute the selected FD basis vectors on the one of the multiple samples of the CSI-RS (e.g., compute W_{f}(t₁) on t₁ and report W_{f}(t₁)).

However, as the co-phasing coefficients between selected DFT beams (i.e., in spatial domain) and the selected FD basis vectors change with different time instances, W₂ needs to be computed and reported at each instance t₁, t₂, and t₃(i.e., W₂(t₁), W₂(t₂), and W₂(t₃) computed at times t₁, t₂, and t₃).

In one embodiment, W₁(t₁), W_{f}(t₁) and W₂(t₁) are reported in one reporting instance, while W₂(t₂) and W₂(t₃) are reported in separate reporting instances.

In another embodiment, W₁(t₁), W_{f}(t₁) and W₂(t₁) are reported in a first reporting instance, while W₂(t₂) and W₂(t₃) are jointly reported in a second reporting instances.

In yet another embodiment, W₁(t₁), W_{f}(t₁), W₂(t₁), W₂(t₂) and W₂(t₃) are reported jointly in a single reporting instance.

In the above embodiments, the reporting instances may be reported via either PUSCH or PUCCH.

With W₂(t₁), W₂(t₂) and W₂(t₃), the network (e.g., a network node such as a base station 302, e.g., a gNB) can derive the phase change for each W₂ coefficient over time instances {t₁, t₂, t₃} and thus estimate the underlying corresponding Doppler frequency or phase slope over the time period based on some criteria such as MSE. An example of phase slot for a coefficient of W₂(t) is illustrated in FIG. 6. The estimated Doppler frequency or phase slope can then be used to predict the corresponding W₂ coefficient in a future time instance.

Alternatively, instead of reporting W₂(t₂) and W₂(t₃), the phase difference of each coefficient of W₂ in different time instances with respect to the first time instance are reported. In a further embodiment, the phase slope of each coefficient of W₂ over the time window is reported.

### 3 Indication of Multiple CSI-RS Samples Via a Higher Layer Parameter in NZP CSI-RS Resource Set

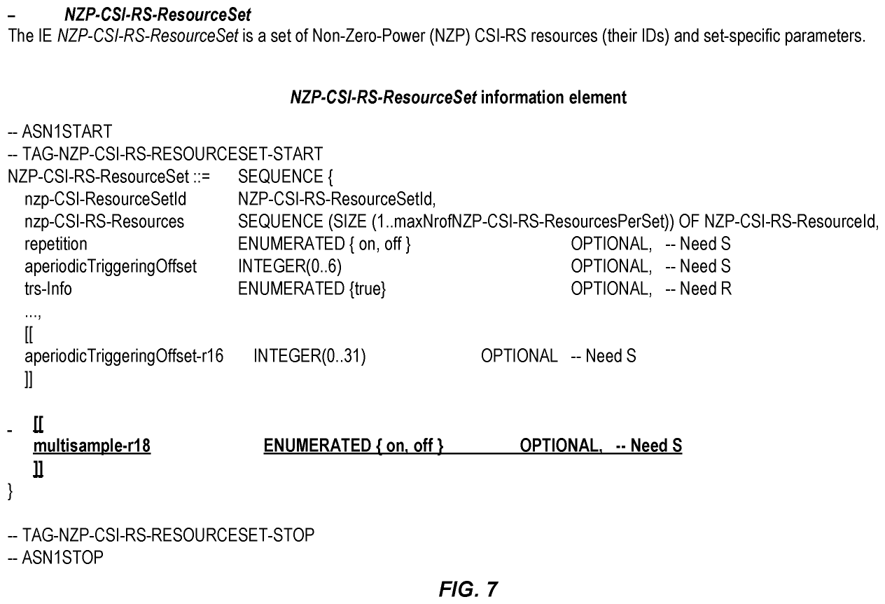

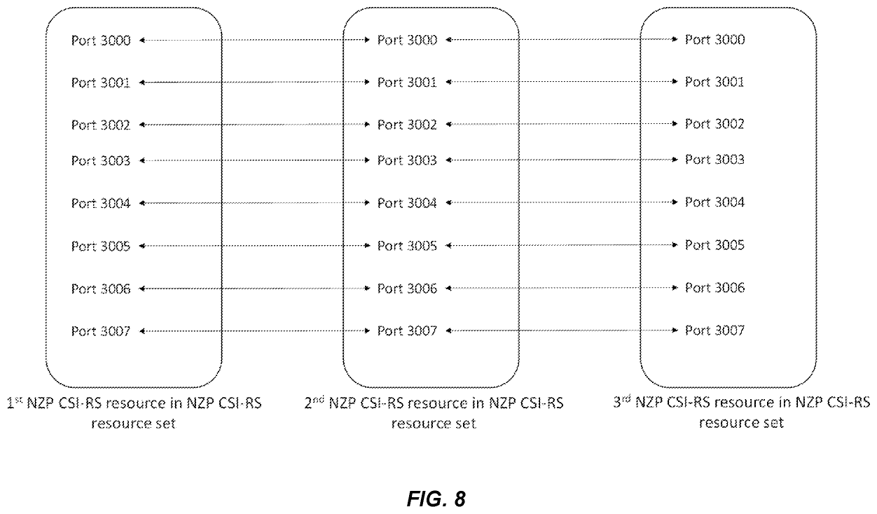

In one embodiment, the multiple samples are configured to the UE 312 as different NZP CSI-RS resources in a NZP CSI-RS resource set. To inform the UE 312 that the NZP CSI-RS resources configured in the NZP CSI-RS resource set correspond to different samples of the same NZP CSI-RS, a higher layer parameter can be configured to the UE 312, e.g., in the NZP-CSI-RS-ResourceSet information element (IE) (see 3GPP TS 38.331 V16.6.0 for definition of NZP-CSI-RS-ResourceSet IE). An example of such configuration is given in FIG. 7. In this example, when higher layer parameter “multisample-r18” is configured as ‘on’, then the NZP CSI-RS resources in the NZP CSI-RS resource set are interpreted by the UE 312 as multiple samples of the same NZP CSI-RS. If “multisample-r18” is configured as ‘off’ or if “multisample-r18” is absent (i.e., if it is not configured), then the UE 312 does not assume that the NZP CSI-RS resources in the NZP CSI-RS resource set are multiple samples of the same NZP CSI-RS.

The number of samples may also need to be configured to the UE 312. In some embodiments, the number of samples is always equal to the number of NZP CSI-RS resources in the configured NZP CSI-RS resource set. Then, the UE 312 can infer the number of samples from the configured NZP CSI-RS resource set, hence no explicit signaling is needed. In some other embodiments, the number of samples and/or the samples that should be used for CSI calculation may be explicitly signaled to the UE 312. This signaling can either be separately encoded, or jointly encoded with the high layer parameter for triggering the multi-sample CSI-RS. In some embodiments, explicitly signaled number of samples can be included as a higher layer parameter in the NZP-CSI-RS-ResourceSet IE.

In some embodiments, the CSI-RS resource mapping and/or the time domain location configured for each of the NZP CSI-RS resources in the NZP CSI-RS resource set are different. However, other parameters (for instance, except CSI-RS resource mapping and/or the time domain location) may be similar between the NZP CSI-RS resources in the NZP CSI-RS resource set. Hence, to save signaling overhead, these other parameters may not need to be signaled for each of the NZP CSI-RS resources.

In one embodiment, these other parameters are only configured for one of the NZP CSI-RS resources (e.g., the first NZP CSI-RS resource in the NZP CSI-RS resource set), and the UE interprets that these parameters apply to all the NZP CSI-RS resources in the NZP CSI-RS resource set when higher layer parameter “multisample-r18” is configured as ‘on’.

FIG. 7 illustrates an example of configuring multi-sample CSI-RS as part of NZP CSI-RS Resource set.

### 3.1 Assumption on Antenna Ports in Different NZP CSI-RS Resources

In another embodiment, all the NZP CSI-RS resources configured in the NZP CSI-RS resource set have the same number M of antenna ports (i.e., all the NZP CSI-RS resources in the NZP CSI-RS resource set are configured with the same value for higher layer parameter ‘nrofPorts’ as defined in 3GPP TS 38.331 V16.6.0). In this case, when the NZP CSI-RS resources in the NZP CSI-RS resource set are multiple samples of the same NZP CSI-RS, it means that the m^{th} antenna port (m=0, 1, . . . , M−1) for all NZP CSI-RS resources in the NZP CSI-RS resource set is the same. This can be interpreted as the m^{th} antenna port (m=0, 1, . . . , M−1) for all NZP CSI-RS resources in the NZP CSI-RS resource set being transmitted using any one of an antenna element, a subarray consisting of a group of antenna elements, or a beam. That is, the 1^{st} antenna port for all NZP CSI-RS resources in the NZP CSI-RS resource set is the same, the 2^{nd} antenna port for all NZP CSI-RS resources in the NZP CSI-RS resource set is the same, and so on. Note that the condition ‘same antenna port for all NZP CSI-RS resources in the NZP CSI-RS resource set’ shall be met for all M antenna ports. FIG. 8 shows an example where three 8-port NZP CSI-RS resources in a NZP CSI-RS resource set are configured as multiple samples of the same NZP CSI-RS. In this example, we have:
port 3000 in the 1^{st}, 2^{nd}, and 3^{rd} NZP CSI-RS resources is the same;
port 3001 in the 1^{st}, 2^{nd}, and 3^{rd} NZP CSI-RS resources is the same;
port 3002 in the 1^{st}, 2^{nd}, and 3^{rd} NZP CSI-RS resources is the same;
port 3003 in the 1^{st}, 2^{nd}, and 3^{rd} NZP CSI-RS resources is the same;
port 3004 in the 1^{st}, 2^{nd}, and 3^{rd} NZP CSI-RS resources is the same;
port 3005 in the 1^{st}, 2^{nd}, and 3^{rd} NZP CSI-RS resources is the same;
port 3006 in the 1^{st}, 2^{nd}, and 3^{rd} NZP CSI-RS resources is the same; and
port 3007 in the 1^{st}, 2^{nd}, and 3^{rd} NZP CSI-RS resources is the same.

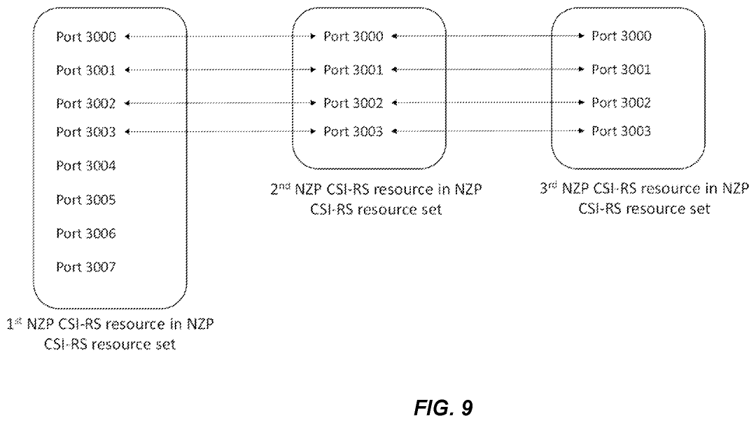

In yet another embodiment, one of the NZP CSI-RS resources in the NZP CSI-RS resource set is configured with M₁ antenna ports, and the remaining NZP CSI-RS resources in the NZP CSI-RS resource set are configured with a smaller number of M₂ antenna ports where M₂<M₁. For example, the NZP CSI-RS resource with the larger number of ports may be the NZP CSI-RS resource that occurs earliest in time among the multiple NZP CSI-RS resources in the NZP CSI-RS resource set (e.g., the earliest NZP CSI-RS resource may correspond to the NZP CSI-RS resource at time t₁ in FIG. 4). The benefit here is that the NZP CSI-RS overhead with multi-sample CSI-RS may be reduced as a smaller number of antenna ports M₂ may be used for all NZP CSI-RS resources except one of the NZP CSI-RS resources in the NZP CSI-RS resource set. In this reduced overhead mechanism for configuring multi-sample CSI-RS, the m^{th} antenna port (m=0,1, . . . , M₂-1), for up to the first M₂ antenna ports, for all NZP CSI-RS resources in the NZP CSI-RS resource set is the same. This can be interpreted as the m^{th} antenna port (m=0,1, . . . , M₂-1) for all NZP CSI-RS resources in the NZP CSI-RS resource set being transmitted using any one of an antenna element, a subarray consisting of a group of antenna elements, or a beam. FIG. 9 shows an example where one 8-port NZP CSI-RS resource and two 4-port NZP CSI-RS resources in a NZP CSI-RS resource set are configured as multiple samples of the same NZP CSI-RS. In this example, we have:
port 3000 in the 1^{st}, 2^{nd}, and 3^{rd} NZP CSI-RS resources is the same;
port 3001 in the 1^{st}, 2^{nd}, and 3^{rd} NZP CSI-RS resources is the same;
port 3002 in the 1^{st}, 2^{nd}, and 3^{rd} NZP CSI-RS resources is the same;
port 3003 in the 1^{st}, 2^{nd}, and 3^{rd} NZP CSI-RS resources is the same;

In another example, the M₂ ports may be associated with only a single polarization, and the CSI-RS overhead can be reduced by roughly half. This could work since the time domain channel property, e.g., doppler, is common for both polarizations. In one variant of the embodiment, M₂₌₁ in the above embodiments where multiple NZP CSI-RS resources except one NZP CSI-RS resource in the NZP CSI-RS resource set may be configured with single CSI-RS port. In this case, only one NZP CSI-RS resource in the resource set is configured with M₁>1 CSI-RS ports.

### 3.2 TCI State Indication for Periodic NZP CSI-RS Resources

In some embodiments, when the NZP CSI-RS resources in the NZP CSI-RS resource set are periodic, qcl-InfoPeriodicCSI-RS as defined in 3GPP TS 38.331 V16.6.0, which provides the TCI State ID related to the NZP CSI-RS, is configured to be the same for all NZP CSI-RS resources in the NZP CSI-RS resource set (i.e., the same value for the qcl-InfoPeriodicCSI-RS parameter is configured for all NZP CSI-RS resources in the NZP CSI-RS resource set).

In one embodiment, when the NZP CSI-RS resources are periodic, the parameter qcl-InfoPeriodicCSI-RS which provides the TCI State ID is only configured in the first NZP CSI-RS resource in the NZP CSI-RS resource set (the parameter qcl-InfoPeriodicCSI-RSis not configured in the remaining CSI-RS resources except the first NZP CSI-RS resource in the NZP CSI-RS resource set). Given the NZP CSI-RS resource set is configured for multi-sample CSI-RS (e.g., a flag ‘multisample-r18’ is configured to be ‘on’ or present in the NZP CSI-RS resource set), the UE interprets that the TCI state ID provided by the qcl-InfoPeriodicCSI-RS parameter configured in the first NZP CSI-RS resource in the NZP CSI-RS resource set should apply to the remaining NZP CSI-RS resources in the NZP CSI-RS resource set as well. A benefit of this embodiment is that qcl-InfoPeriodicCSI-RS does not have to be configured in all the NZP CSI-RS resources in the NZP CSI-RS resource set, thus saving higher layer signaling overhead.

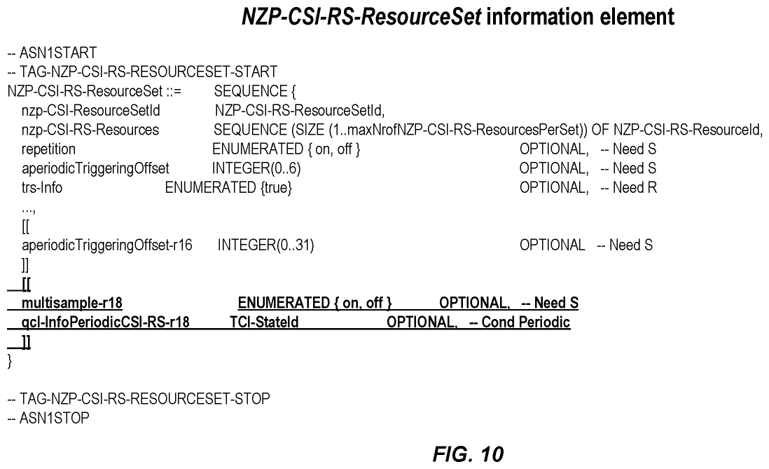

In another embodiment, when the NZP CSI-RS resources are periodic, the parameter qcl-InfoPeriodicCSI-RS-r18 which provides the TCI State ID for the NZP CSI-RS resources in the NZP CSI-RS resource set is configured in the NZP-CSI-RS-ResourceSet IE as shown in FIG. 10. When the UE 312 is configured with multi-sample CSI-RS in the NZP CSI-RS resource set (e.g., a flag ‘multisample-r18’ is configured to be ‘on’ or present in the NZP CSI-RS resource set), the UE 312 interprets that the TCI state ID provided by the qcl-InfoPeriodicCSI-RS parameter configured in the NZP CSI-RS resource set should apply to all NZP CSI-RS resources in the NZP CSI-RS resource set. When the UE 312 is not configured with multi-sample CSI-RS in the NZP CSI-RS resource set (e.g., a flag ‘multisample-r18’ is configured to be ‘off’ or not present in the NZP CSI-RS resource set), the UE 312 may not be configured with the qcl-InfoPeriodicCSI-RS-r18 parameter at the NZP CSI-RS set level (instead, for this case, the each NZP CSI-RS resource may be configured with a qcl-InfoPeriodicCSI-RS per each periodic CSI-RS resource in the NZP CSI-RS resource set).

### 3.3 TCI State Indication for Semi-Persistent NZP CSI-RS Resources

In some embodiments, when the NZP CSI-RS resources in the NZP CSI-RS resource set are semi-persistent, the same TCI State ID is indicated to all the NZP CSI-RS resources in a MAC CE that activates the semi-persistent NZP CSI-RS resource set. For instance, if there are/semi-persistent NZP CSI-RS resources in the semi-persistent NZP CSI-RS resource set, the MAC CE that activates the NZP CSI-RS resource set contains/VTCI State IDs set the same value (where each TCI state ID indicates the TCI state to be applied to each of the NNZP CSI-RS resources).

In another embodiment, when the NZP CSI-RS resources are semi-persistent, only a single TCI State ID is indicated in a MAC CE that activates the semi-persistent NZP CSI-RS resource set. The single TCI state ID provides the TCI State to be applied to all of the semi-persistent NZP CSI-RS resources in the semi-persistent NZP CSI-RS resource set. A benefit of this embodiment is that multiple TCI State IDs do not have to be signaled in the MAC CE that activates the semi-persistent NZP CSI-RS resource set, thus saving MAC CE signaling overhead.

In another embodiment, when the NZP CSI-RS resources are semi-persistent, a TCI state ID parameter which provides the TCI State ID for all the NZP CSI-RS resources in the NZP CSI-RS resource set is configured in the NZP-CSI-RS-ResourceSet IE (similar to qcl-InfoPeriodicCSI-RS-r18 parameter shown in FIG. 10). When the UE 312 is configured with multi-sample CSI-RS in the NZP CSI-RS resource set (e.g., a flag ‘multisample-r18’ is configured to be ‘on’ or present in the NZP CSI-RS resource set), the UE 312 interprets that the TCI state ID provided in the NZP CSI-RS resource set should apply to all NZP CSI-RS resources in the NZP CSI-RS resource set.

### 3.4 TCI State Indication for Aperiodic NZP CSI-RS Resources

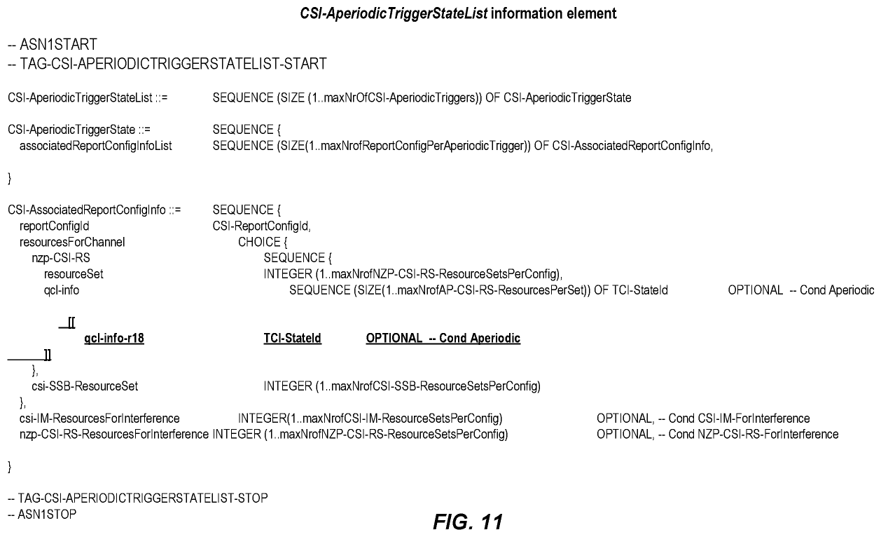

In some embodiments, when the NZP CSI-RS resources in the NZP CSI-RS resource set are aperiodic, the same TCI State ID is indicated to all the NZP CSI-RS resources in the aperiodic NZP CSI-RS resource set. When an uplink DCI triggers an aperiodic CSI-RS resource set, a codepoint in the ‘CSI request field’ in the uplink DCI will point to one CSI-AperiodicTriggerState as specified in the CSI-AperiodicTriggerStateList IE in 3GPP TS 38.331 V16.6.0. Each CSI-AperiodicTriggerState will trigger an CSI-AssociatedReportConfigInfo which contains an NZP CSI-RS resource set for channel measurement. When the NZP CSI-RS resource set is aperiodic and the NZP CSI-RS resource set is configured for multi-sample CSI-RS (e.g., a flag ‘multisample-r18’ is configured to be ‘on’ or present in the NZP CSI-RS resource set), then in some embodiments a single TCI state ID is provided as part of CSI-AssociatedReportConfigInfo which should be applied to all the aperiodic NZP CSI-RS resources in the NZP CSI-RS resource set. An example is shown in FIG. 11, where the parameter qcl-info-r18, which contains a single TCI state ID, provides the TCI state to be applied to all the aperiodic NZP CSI-RS resources in the NZP CSI-RS resource set. Note that when qcl-info-r18 is configured qcl-info parameter which would have provided multiple TCI State IDs (one TCI state ID per aperiodic CSI-RS resource) is not configured in the CSI-AssociatedReportConfigInfo.

In another embodiment, when the NZP CSI-RS resources are aperiodic, a TCI state ID parameter which provides the TCI State ID for all the NZP CSI-RS resources in the NZP CSI-RS resource set is configured in the NZP-CSI-RS-ResourceSet IE (similar to qcl-InfoPeriodicCSI-RS-r18 parameter shown in FIG. 10). When the UE 312 is configured with multi-sample CSI-RS in the NZP CSI-RS resource set (e.g., a flag ‘multisample-r18’ is configured to be ‘on’ or present in the NZP CSI-RS resource set), the UE 312 interprets that the TCI state ID provided in the NZP CSI-RS resource set should apply to all NZP CSI-RS resources in the NZP CSI-RS resource set.

### 3.5 TCI State Indication via Unified TCI Framework

In another embodiment, when the NZP CSI-RS resources in the NZP CSI-RS resource set are periodic/semi-persistent/aperiodic, the unified TCI state currently activated to the UE 312 (either “Joint DL/UL TCI state” or DL TCI state) is applied to all NZP CSI-RS resources in the NZP CSI-RS resource set.

3.6 Differences from Prior Solutions

It should be noted that the embodiments proposed above are different from the case when parameter ‘trs-info’ is configured to ‘true’ in the NZP CSI-RS Resource set. When ‘trs-info’ is configured to true in the NZP CSI-RS resource set, the NZP CSI-RS resources in the NZP CSI-RS resource set (which are tracking reference signals or TRSs) can be used by the UE to derive time domain channel properties such as Doppler shift, Doppler spread, etc. However, up to NR Release-17, the UE does not report any CSI on the TRS resources. Using the solutions proposed herein, the UE 312 can perform Precoding Matrix Indicator (PMI) computations corresponding to extended Type-I or Type-II CSI as described in Sections 1 and 2 above using the multi-sample NZP CSI-RS, and can report the computed extended Type-I or Type-II CSI to the network. In addition to PMI, the extended Type-I or Type-II CSI may include one or more of Rank Indicator (RI), Layer Indicator (LI), and Channel Quality Indicator (CQI). Another difference is that TRS only allows measurements on a single antenna port while the solutions proposed herein allow multi-sample measurements on NZP CSI-RS for M>1 antenna ports.

Furthermore, the embodiments proposed above are also different from the case when parameter ‘repetition’ is configured to ‘on’ in the NZP CSI-RS resource set. When parameter ‘repetition’ is configured to ‘on’, the NZP CSI-RS resources in the NZP CSI-RS resource sets can be used by the UE to measure and report Layer 1 RSRP (L1-RSRP) or Layer 1 (L1-SINR). However, the solutions proposed herein allow the UE to perform PMI computations corresponding to extended Type-I or Type-II CSI as described above.

4 Indication of Multiple CSI-RS Samples via Indicating Offsets Associated with Multiple CSI-RS Samples

### 4.1 Intra-Slot CSI-RS Repetition

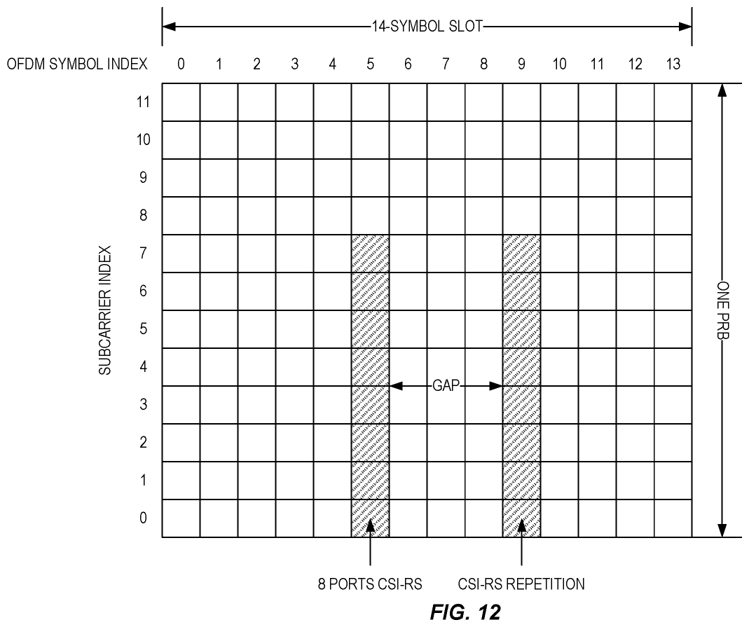

In one embodiment, only a single NZP CSI-RS resource may be configured in a NZP CSI-RS resource set. The CSI-RS resource may be repeated within a slot when triggered. The repetition may be either configured in the CSI report configuration, dynamically indicated in DCI triggering the CSI report, or activated by a MAC CE that activates the CSI report. Note that in these embodiments the different repetitions represent the different samples of the NZP CSI-RS. The number of repetitions may be pre-specified, e.g., fixed to 2 repetitions. Alternatively, the number of repetitions may be linked to the number of CSI-RS ports in the CSI-RS resource. For example, for 16 or 32 CSI-RS ports, the number of repetitions are fixed to 2. For 8 CSI-RS ports, the number of repetitions may be more than 2, e.g., 3 or 4 and one of them may be either configured or dynamically indicated in the DCI. A gap in number of OFDM symbols may also be configured between two repetitions. An example is shown in FIG. 12, where 8 ports CSI-RS resource is repeated two times in a slot with a gap of three OFDM symbols. In some embodiments, the gap size and/or the number of repetitions are higher layer configured to the UE (e.g., via RRC). In some embodiments, the gap size and/or the number of repetitions may be configured as part of higher layer parameters in any one of the following IEs:
NZP-CSI-RS-Resource IE defined in 3GPP TS 38.331 V16.6.0
CSI-RS-ResourceMapping IE defined in 3GPP TS 38.331 V16.6.0
NZP-CSI-RS-ResourceSet IE defined in 3GPP TS 38.331 V16.6.0
as part of CSI-AssociatedReportConfigInfo in the CSI-AperiodicTriggerStateList IE defined in 3GPP TS 38.331 V16.6.0
CSI-ReportConfig IE defined in 3GPP TS 38.331 V16.6.0

In an alternative embodiment, assuming N repetitions (i.e., samples) of NZP CSI-RS in the slot, an alternative way may be to signal the time domain offsets (in symbols) corresponding to the remaining N-1 samples with respect to the first sample.

In some embodiments, multiple gap sizes may be signaled to the UE 312 by the network in order to support the use case where the multiple NZP CSI-RS samples are non-uniformly spaced. Considering the example shown in FIG. 4, to a first gap spacing of 2 symbols between samples at times t₁ and t₂ may be higher layer configured to the UE 312 by the network. In addition, a second gap spacing of 3 symbols between the samples at times t₂ and t₃ may be higher layer configured to the UE 312 by the network.

In another embodiment, a single gap size may be signaled to the UE 312 by the network in order to support the use case where the multiple NZP CSI-RS samples are uniformly spaced. In this embodiment, referring to the example shown in FIG. 4, the gap spacing between samples at times t₁ and t₂ is given by the signaled/configured single gap size. The gap spacing between samples at times t₂ and t₃ is also given by the same single gap size.

In some embodiments, for a single NZP CSI-RS resource, the firstOFDMSymbolInTimeDomain and firstOFDMSymbolInTimeDomain2 in the CSI-RS-ResourceMapping (as defined in 3GPP TS 38.331 V16.6.0) associated with the NZP CSI-RS resource provides the time domain symbols for the first NZP CSI-RS repetition (or first NZP CSI-RS sample) within the slot. The time domain location for the second NZP CSI-RS sample is determined by offsetting the firstOFDMSymbolIn TimeDomain and firstOFDMSymbolInTimeDomain2 by the sample gap size between the first NZP CSI-RS sample and the second NZP CSI-RS sample (i.e., time domain location for the second NZP CSI-RS sample determined by firstOFDMSymbolInTimeDomain+g1 and firstOFDMSymbolInTimeDomain2+g1 where g1 is the sample gap size between the first and the second NZP CSI-RS samples).

The time domain location for the third NZP CSI-RS sample is determined by offsetting the firstOFDMSymbolInTimeDomain and firstOFDMSymbolInTimeDomain2 by the sample gap sizes between the first NZP CSI-RS sample and the second NZP CSI-RS sample, and between the second NZP CSI-RS sample and the third NZP CSI-RS sample (i.e., time domain location for the third NZP CSI-RS sample determined by firstOFDMSymbolInTimeDomain+g1+g2 and firstOFDMSymbolInTimeDomain2+g1+g2 where g1 is the sample gap size between the first and the second NZP CSI-RS samples, g1 is the sample gap size between the second and the third NZP CSI-RS samples).

### 4.2 Inter-Slot CSI-RS Repetition

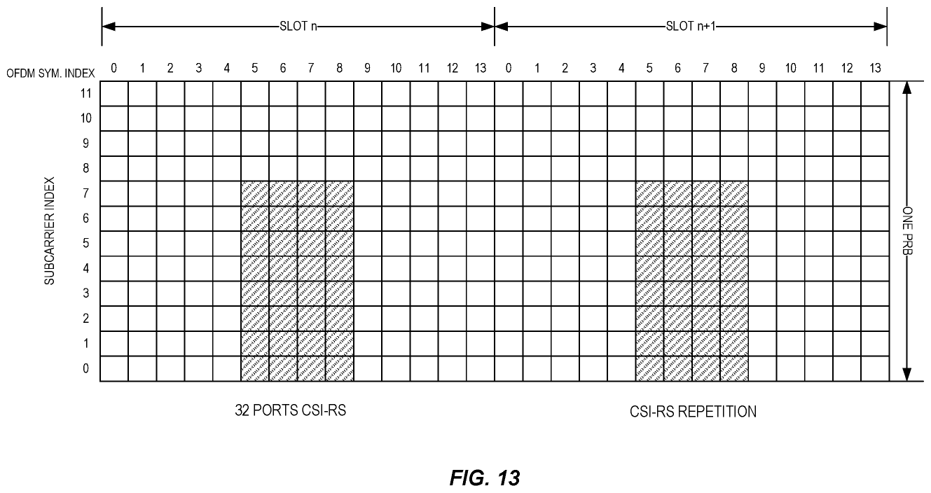

In another embodiment, a CSI-RS resource may be repeated across slots when triggered. The repetition may be either configured in the corresponding CSI report configuration, dynamically indicated in DCI triggering the CSI report, or indicated via a MAC CE activating the CSI report. The number of repetitions may be pre-specified, e.g., fixed to 2 repetitions. Alternatively, the number of repetitions may be dynamically indicated in the DCI, or indicated via a MAC CE. The same time and frequency resource is used in each of the repeated slots for the CSI-RS resource. An example is shown in FIG. 13, where a 32-ports CSI-RS resource is repeated in two consecutive slots.

In some embodiments, the configured/indicated/signaled number of repetitions (i.e., samples) are received in adjacent slots. In this embodiment, if the time/frequency resource allocation for a particular NZP CSI-RS sample in a particular slot collides with an SSB or at least one uplink symbol, then that particular NZP CSI-RS sample is dropped, and CSI is not measured using that NZP CSI-RS sample.

In another embodiment, the configured/indicated/signaled number of NZP CSI-RS repetitions (i.e., samples) are received in non-adjacent slots. Which slots should carry the different number of NZP CSI-RS repetitions may be indicated in different ways. For instance, a bit map of a predefined length may be used for this purpose. In this bitmap, each bit indicates whether a NZP CSI-RS sample is present in a particular slot or not. A bit value of 1 may indicate that a NZP CSI-RS sample is present in that particular slot. Alternatively, one or more gap sizes between different samples may be configured to indicate which slots contain a NZP CSI-RS sample.

In a further embodiment, both intra-slot and inter-slot repetitions may be configured for a CSI-RS resource associated with a CSI report.

To ensure correct CSI measurement, phase continuity among the CSI-RS repetitions within a slot or across slots is needed.

### 5 Periodic or Semi-Persistent CSI-RS

Periodic or semi-persistent CSI-RS can be configured to the UE 312. The benefit is that the same CSI-RS can be shared among multiple UEs to save the CSI-RS overhead. In this case, the UE 312 needs to determine which samples are to be used for CSI calculation. In some embodiments, the UE 312 is configured explicitly by the network (e.g., network node such as a base station, e.g., gNB) with which samples to use for CSI calculation. For example, such configuration can explicitly indicate the time domain locations of CSI-RS samples to be used. In some other embodiments, the UE 312 can be configured with the number of samples to use. The above configurations can either be configured in the corresponding CSI report configuration or dynamically indicated in DCI triggering the CSI report.

### 6 Further Description

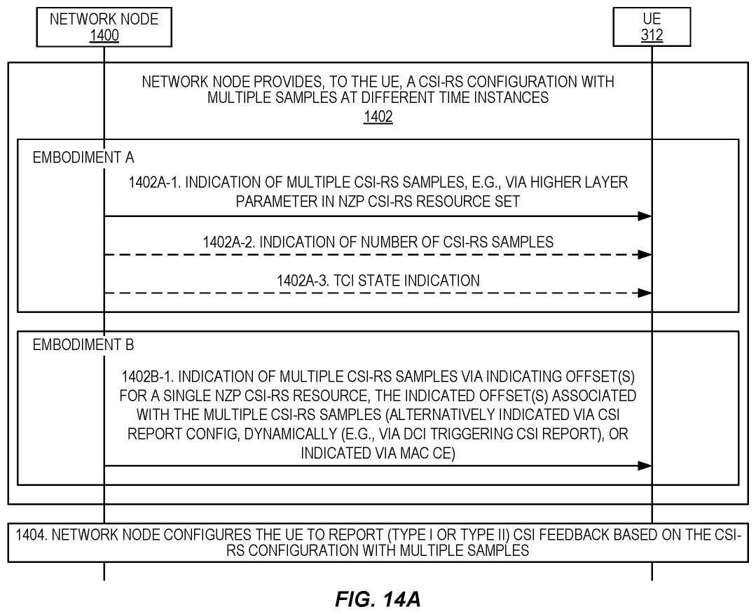

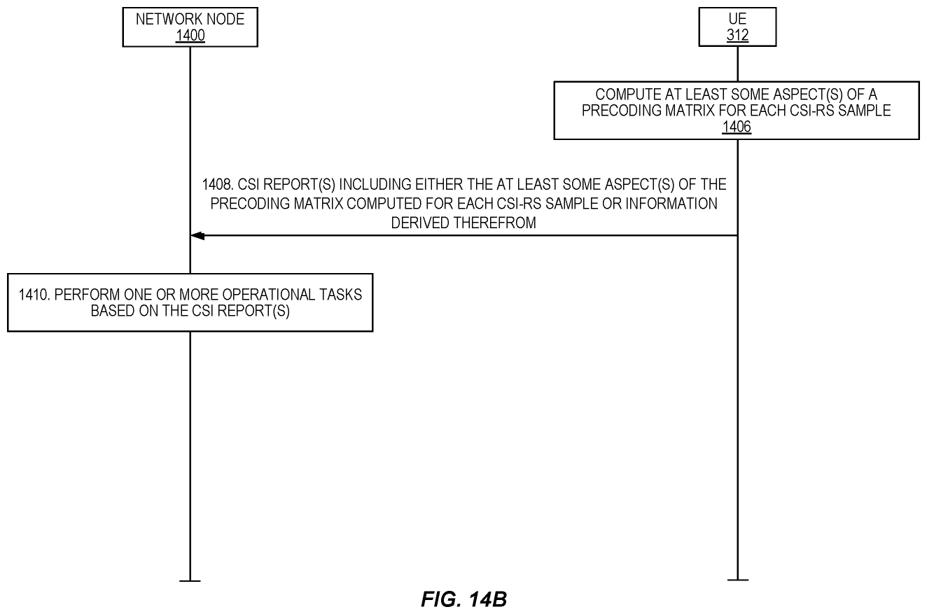

FIGS. 14A and 14B illustrate the operation of a network node 1400 and a UE 312 in accordance with at least some of the embodiments described above. The network node 1400 may be, e.g., a base station 302, a RAN node that performs at least some of the functionality of the base station 302 (e.g., a gNB-CU), or some other network node. Optional steps are represented as dashed lines/boxes. Note that the details of the various embodiments above described in Sections 1 to 5 are applicable to the relevant steps of the procedure of FIGS. 14A and 14B.

As illustrated, the network node 1400 provides, to the UE 312, first information that provides a CSI-RS configuration with a plurality of CSI-RS samples at different time instances (step 1402). As described above, in one embodiment (“Embodiment A”), step 1402 includes the network node 1400 providing, to the UE 312, an indication of multiple CSI-RS samples (e.g., indicated as multiple NZP CSI-RS resources in a NZP CSI-RS resource set), e.g., via higher layer parameter (e.g., a parameter that indicates to the UE 312 that the UE 312 is to interpret the multiple NZP CSI-RS resources in the NZP CSI-RS resource set as the multiple CSI-RS samples of the same CSI-RS) (step 1402A-1). In addition, the network node 1400 may provide, to the UE 312, an explicit or implicit indication of the number of CSI-RS samples (step 1402A-2). The network node 1400 may provide information that indicates a TCI state ID for the CSI-RS samples (step 1402A-3). Further details regarding steps 1402A-1, 1402A-2, and 1402A-3 and associated embodiments can be found, e.g., in Section 3 above. Those details are equally applicable here.

Alternatively, in another embodiment (“Embodiment B”) of step 1402, the network node 1400 provides, to the UE 312, an indication of the multiple CSI-RS samples via providing information that indicates multiple repetitions of a single NZP CSI-RS resource (e.g., via indicating time offset(s) or time gap(s) between the multiple repetitions of the single NZP CSI-RS resource) (step 1402B-1). Alternatively, the repetitions of the single NZP CSI-RS resource may be indicated via a CSI report configuration, dynamically (e.g., via DCI triggering CSI report), or indicated via MAC CE, or the like. Further details regarding step 1402B-1 and associated embodiments can be found, e.g., in Section 4 above. Those details are equally applicable here.

It should also be noted that the information provided to the UE 312 in step 1402 may be sent via one or more messages using one or more signaling types (e.g., RRC, MAC, DCI, or combination of any two or more thereof).

The network node 1400 sends, to the UE 312, second information (e.g., a CSI report configuration) that configures the UE to report CSI feedback (e.g., Type I or Type II) based on the CSI-RS configuration with multiple CSI-RS samples (step 1404). The UE 312 computes at least some aspect(s) of a precoding matrix for each CSI-RS sample (step 1406) and reports this information or information derived therefrom via one or more CSI-RS reports (step 1408), in accordance with the configuration of step 1404. Details of what information is computed and reported can be found above, e.g., in Section 1(Type I) and Section 2(Type II). Those details are equally applicable here.

The network node 1400 may then perform one or more operational tasks based on the CSI report(s) (step 1410). For example, the network node 1400 may utilize this information for downlink MU-MIMO precoding.

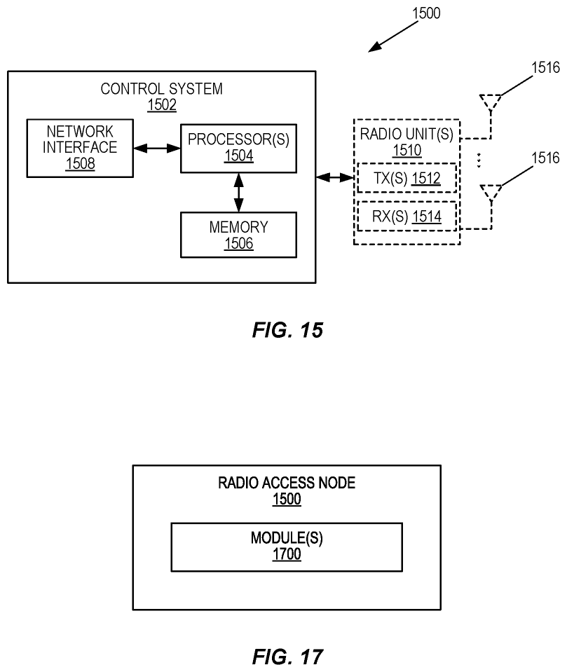

FIG. 15 is a schematic block diagram of a radio access node 1500 according to some embodiments of the present disclosure. Optional features are represented by dashed boxes. The radio access node 1500 may be, for example, a base station 302 or 306 or a network node that implements all or part of the functionality of the base station 302 or gNB described herein. As illustrated, the radio access node 1500 includes a control system 1502 that includes one or more processors 1504 (e.g., Central Processing Units (CPUs), Application Specific Integrated Circuits (ASICs), Field Programmable Gate Arrays (FPGAs), and/or the like), memory 1506, and a network interface 1508. The one or more processors 1504 are also referred to herein as processing circuitry. In addition, the radio access node 1500 may include one or more radio units 1510 that each includes one or more transmitters 1512 and one or more receivers 1514 coupled to one or more antennas 1516. The radio units 1510 may be referred to or be part of radio interface circuitry. In some embodiments, the radio unit(s) 1510 is external to the control system 1502 and connected to the control system 1502 via, e.g., a wired connection (e.g., an optical cable). However, in some other embodiments, the radio unit(s) 1510 and potentially the antenna(s) 1516 are integrated together with the control system 1502. The one or more processors 1504 operate to provide one or more functions of a radio access node 1500 as described herein. In some embodiments, the function(s) are implemented in software that is stored, e.g., in the memory 1506 and executed by the one or more processors 1504.

FIG. 16 is a schematic block diagram that illustrates a virtualized embodiment of the radio access node 1500 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1500 in which at least a portion of the functionality of the radio access node 1500 is implemented as a virtual component(s) (e.g., via a virtual machine(s) executing on a physical processing node(s) in a network(s)). As illustrated, in this example, the radio access node 1500 may include the control system 1502 and/or the one or more radio units 1510, as described above. The control system 1502 may be connected to the radio unit(s) 1510 via, for example, an optical cable or the like. The radio access node 1500 includes one or more processing nodes 1600 coupled to or included as part of a network(s) 1602. If present, the control system 1502 or the radio unit(s) are connected to the processing node(s) 1600 via the network 1602. Each processing node 1600 includes one or more processors 1604 (e.g., CPUs, ASICs, FPGAS, and/or the like), memory 1606, and a network interface 1608.

In this example, functions 1610 of the radio access node 1500 described herein are implemented at the one or more processing nodes 1600 or distributed across the one or more processing nodes 1600 and the control system 1502 and/or the radio unit(s) 1510 in any desired manner. In some particular embodiments, some or all of the functions 1610 of the radio access node 1500 described herein are implemented as virtual components executed by one or more virtual machines implemented in a virtual environment(s) hosted by the processing node(s) 1600. As will be appreciated by one of ordinary skill in the art, additional signaling or communication between the processing node(s) 1600 and the control system 1502 is used in order to carry out at least some of the desired functions 1610. Notably, in some embodiments, the control system 1502 may not be included, in which case the radio unit(s) 1510 communicate directly with the processing node(s) 1600 via an appropriate network interface(s).

In some embodiments, a computer program including instructions which, when executed by at least one processor, causes the at least one processor to carry out the functionality of radio access node 1500 or a node (e.g., a processing node 1600) implementing one or more of the functions 1610 of the radio access node 1500 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 17 is a schematic block diagram of the radio access node 1500 according to some other embodiments of the present disclosure. The radio access node 1500 includes one or more modules 1700, each of which is implemented in software. The module(s) 1700 provide the functionality of the radio access node 1500 described herein. This discussion is equally applicable to the processing node 1600 of FIG. 16 where the modules 1700 may be implemented at one of the processing nodes 1600 or distributed across multiple processing nodes 1600 and/or distributed across the processing node(s) 1600 and the control system 1502.

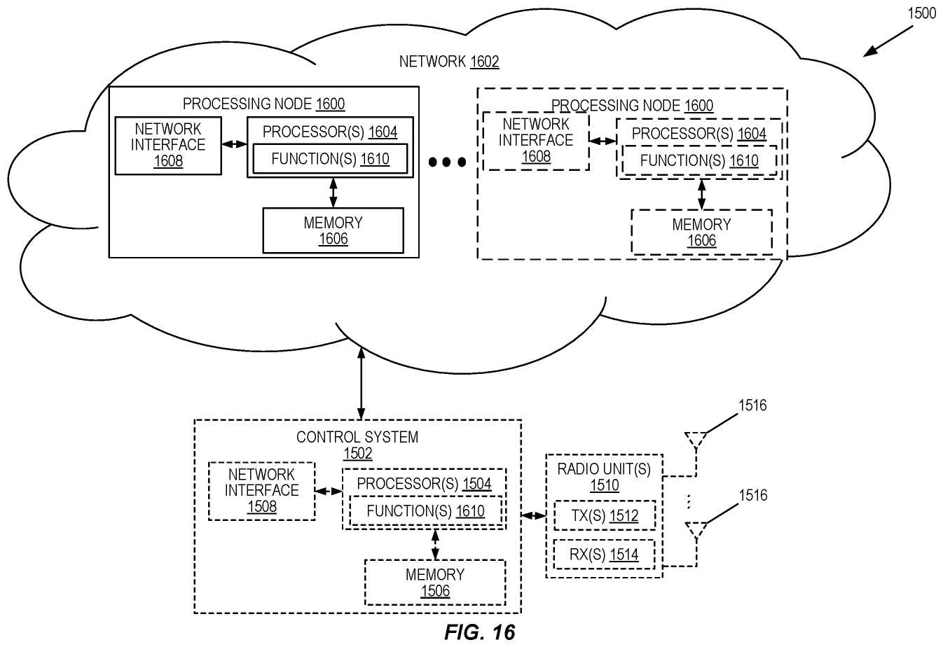

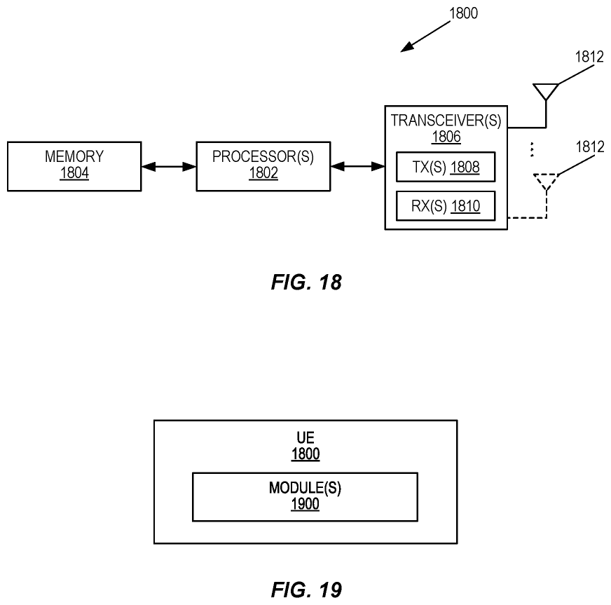

FIG. 18 is a schematic block diagram of a wireless communication device 1800 according to some embodiments of the present disclosure. As illustrated, the wireless communication device 1800 includes one or more processors 1802 (e.g., CPUs, ASICS, FPGAs, and/or the like), memory 1804, and one or more transceivers 1806 each including one or more transmitters 1808 and one or more receivers 1810 coupled to one or more antennas 1812. The transceiver(s) 1806 includes radio-front end circuitry connected to the antenna(s) 1812 that is configured to condition signals communicated between the antenna(s) 1812 and the processor(s) 1802, as will be appreciated by on of ordinary skill in the art. The processors 1802 are also referred to herein as processing circuitry. The transceivers 1806 are also referred to herein as radio circuitry. In some embodiments, the functionality of the wireless communication device 1800 described above may be fully or partially implemented in software that is, e.g., stored in the memory 1804 and executed by the processor(s) 1802. Note that the wireless communication device 1800 may include additional components not illustrated in FIG. 18 such as, e.g., one or more user interface components (e.g., an input/output interface including a display, buttons, a touch screen, a microphone, a speaker(s), and/or the like and/or any other components for allowing input of information into the wireless communication device 1800 and/or allowing output of information from the wireless communication device 1800), a power supply (e.g., a battery and associated power circuitry), etc.

In some embodiments, a computer program including instructions which, when executed by at least one processor, causes the at least one processor to carry out the functionality of the wireless communication device 1800 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 19 is a schematic block diagram of the wireless communication device 1800 according to some other embodiments of the present disclosure. The wireless communication device 1800 includes one or more modules 1900, each of which is implemented in software. The module(s) 1900 provide the functionality of the wireless communication device 1800 described herein.

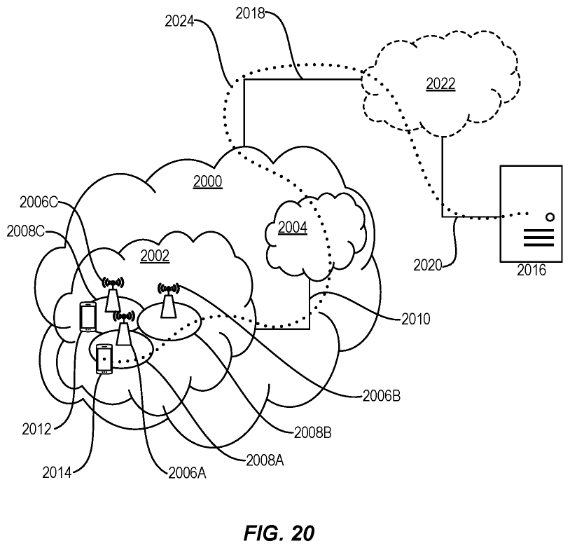

With reference to FIG. 20, in accordance with an embodiment, a communication system includes a telecommunication network 2000, such as a 3GPP-type cellular network, which comprises an access network 2002, such as a RAN, and a core network 2004. The access network 2002 comprises a plurality of base stations 2006A, 2006B, 2006C, such as Node Bs, eNBs, gNBs, or other types of wireless Access Points (APs), each defining a corresponding coverage area 2008A, 2008B, 2008C. Each base station 2006A, 2006B, 2006C is connectable to the core network 2004 over a wired or wireless connection 2010. A first UE 2012 located in coverage area 2008C is configured to wirelessly connect to, or be paged by, the corresponding base station 2006C. A second UE 2014 in coverage area 2008A is wirelessly connectable to the corresponding base station 2006A. While a plurality of UEs 2012, 2014 are illustrated in this example, the disclosed embodiments are equally applicable to a situation where a sole UE is in the coverage area or where a sole UE is connecting to the corresponding base station 2006.

The telecommunication network 2000 is itself connected to a host computer 2016, which may be embodied in the hardware and/or software of a standalone server, a cloud-implemented server, a distributed server, or as processing resources in a server farm. The host computer 2016 may be under the ownership or control of a service provider, or may be operated by the service provider or on behalf of the service provider. Connections 2018 and 2020 between the telecommunication network 2000 and the host computer 2016 may extend directly from the core network 2004 to the host computer 2016 or may go via an optional intermediate network 2022. The intermediate network 2022 may be one of, or a combination of more than one of, a public, private, or hosted network; the intermediate network 2022, if any, may be a backbone network or the Internet; in particular, the intermediate network 2022 may comprise two or more sub-networks (not shown).

The communication system of FIG. 20 as a whole enables connectivity between the connected UEs 2012, 2014 and the host computer 2016. The connectivity may be described as an Over-the-Top (OTT) connection 2024. The host computer 2016 and the connected UEs 2012, 2014 are configured to communicate data and/or signaling via the OTT connection 2024, using the access network 2002, the core network 2004, any intermediate network 2022, and possible further infrastructure (not shown) as intermediaries. The OTT connection 2024 may be transparent in the sense that the participating communication devices through which the OTT connection 2024 passes are unaware of routing of uplink and downlink communications. For example, the base station 2006 may not or need not be informed about the past routing of an incoming downlink communication with data originating from the host computer 2016 to be forwarded (e.g., handed over) to a connected UE 2012. Similarly, the base station 2006 need not be aware of the future routing of an outgoing uplink communication originating from the UE 2012 towards the host computer 2016.

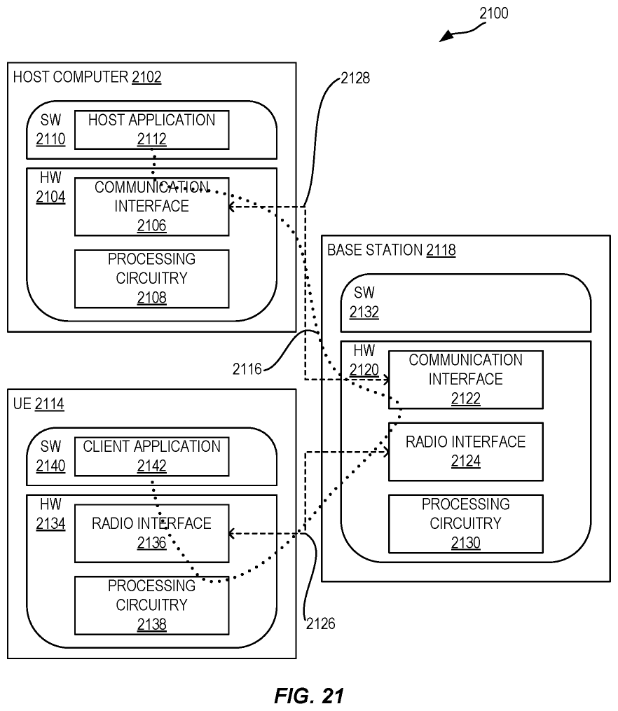

Example implementations, in accordance with an embodiment, of the UE, base station, and host computer discussed in the preceding paragraphs will now be described with reference to FIG. 21. In a communication system 2100, a host computer 2102 comprises hardware 2104 including a communication interface 2106 configured to set up and maintain a wired or wireless connection with an interface of a different communication device of the communication system 2100. The host computer 2102 further comprises processing circuitry 2108, which may have storage and/or processing capabilities. In particular, the processing circuitry 2108 may comprise one or more programmable processors, ASICs, FPGAS, or combinations of these (not shown) adapted to execute instructions. The host computer 2102 further comprises software 2110, which is stored in or accessible by the host computer 2102 and executable by the processing circuitry 2108. The software 2110 includes a host application 2112. The host application 2112 may be operable to provide a service to a remote user, such as a UE 2114 connecting via an OTT connection 2116 terminating at the UE 2114 and the host computer 2102. In providing the service to the remote user, the host application 2112 may provide user data which is transmitted using the OTT connection 2116.

The communication system 2100 further includes a base station 2118 provided in a telecommunication system and comprising hardware 2120 enabling it to communicate with the host computer 2102 and with the UE 2114. The hardware 2120 may include a communication interface 2122 for setting up and maintaining a wired or wireless connection with an interface of a different communication device of the communication system 2100, as well as a radio interface 2124 for setting up and maintaining at least a wireless connection 2126 with the UE 2114 located in a coverage area (not shown in FIG. 21) served by the base station 2118. The communication interface 2122 may be configured to facilitate a connection 2128 to the host computer 2102. The connection 2128 may be direct or it may pass through a core network (not shown in FIG. 21) of the telecommunication system and/or through one or more intermediate networks outside the telecommunication system. In the embodiment shown, the hardware 2120 of the base station 2118 further includes processing circuitry 2130, which may comprise one or more programmable processors, ASICs, FPGAS, or combinations of these (not shown) adapted to execute instructions. The base station 2118 further has software 2132 stored internally or accessible via an external connection.

The communication system 2100 further includes the UE 2114 already referred to. The UE's 2114 hardware 2134 may include a radio interface 2136 configured to set up and maintain a wireless connection 2126 with a base station serving a coverage area in which the UE 2114 is currently located. The hardware 2134 of the UE 2114 further includes processing circuitry 2138, which may comprise one or more programmable processors, ASICS, FPGAs, or combinations of these (not shown) adapted to execute instructions. The UE 2114 further comprises software 2140, which is stored in or accessible by the UE 2114 and executable by the processing circuitry 2138. The software 2140 includes a client application 2142. The client application 2142 may be operable to provide a service to a human or non-human user via the UE 2114, with the support of the host computer 2102. In the host computer 2102, the executing host application 2112 may communicate with the executing client application 2142 via the OTT connection 2116 terminating at the UE 2114 and the host computer 2102. In providing the service to the user, the client application 2142 may receive request data from the host application 2112 and provide user data in response to the request data. The OTT connection 2116 may transfer both the request data and the user data. The client application 2142 may interact with the user to generate the user data that it provides.

It is noted that the host computer 2102, the base station 2118, and the UE 2114 illustrated in FIG. 21 may be similar or identical to the host computer 2016, one of the base stations 2006A, 2006B, 2006C, and one of the UEs 2012, 2014 of FIG. 20, respectively. This is to say, the inner workings of these entities may be as shown in FIG. 21 and independently, the surrounding network topology may be that of FIG. 20.

In FIG. 21, the OTT connection 2116 has been drawn abstractly to illustrate the communication between the host computer 2102 and the UE 2114 via the base station 2118 without explicit reference to any intermediary devices and the precise routing of messages via these devices. The network infrastructure may determine the routing, which may be configured to hide from the UE 2114 or from the service provider operating the host computer 2102, or both. While the OTT connection 2116 is active, the network infrastructure may further take decisions by which it dynamically changes the routing (e.g., on the basis of load balancing consideration or reconfiguration of the network).

The wireless connection 2126 between the UE 2114 and the base station 2118 is in accordance with the teachings of the embodiments described throughout this disclosure. One or more of the various embodiments improve the performance of OTT services provided to the UE 2114 using the OTT connection 2116, in which the wireless connection 2126 forms the last segment.

A measurement procedure may be provided for the purpose of monitoring data rate, latency, and other factors on which the one or more embodiments improve. There may further be an optional network functionality for reconfiguring the OTT connection 2116 between the host computer 2102 and the UE 2114, in response to variations in the measurement results. The measurement procedure and/or the network functionality for reconfiguring the OTT connection 2116 may be implemented in the software 2110 and the hardware 2104 of the host computer 2102 or in the software 2140 and the hardware 2134 of the UE 2114, or both. In some embodiments, sensors (not shown) may be deployed in or in association with communication devices through which the OTT connection 2116 passes; the sensors may participate in the measurement procedure by supplying values of the monitored quantities exemplified above, or supplying values of other physical quantities from which the software 2110, 2140 may compute or estimate the monitored quantities. The reconfiguring of the OTT connection 2116 may include message format, retransmission settings, preferred routing, etc.; the reconfiguring need not affect the base station 2118, and it may be unknown or imperceptible to the base station 2118. Such procedures and functionalities may be known and practiced in the art. In certain embodiments, measurements may involve proprietary UE signaling facilitating the host computer 2102's measurements of throughput, propagation times, latency, and the like. The measurements may be implemented in that the software 2110 and 2140 causes messages to be transmitted, in particular empty or ‘dummy’ messages, using the OTT connection 2116 while it monitors propagation times, errors, etc.

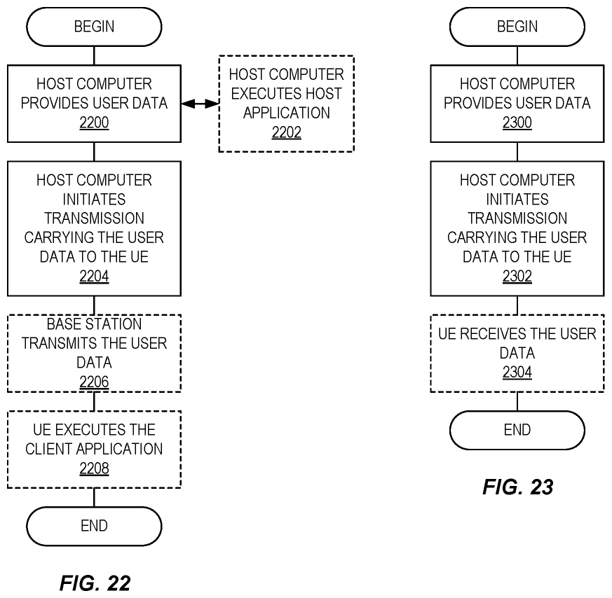

FIG. 22 is a flowchart illustrating a method implemented in a communication system, in accordance with one embodiment. The communication system includes a host computer, a base station, and a UE which may be those described with reference to FIGS. 20 and 21. For simplicity of the present disclosure, only drawing references to FIG. 22 will be included in this section. In step 2200, the host computer provides user data. In sub-step 2202 (which may be optional) of step 2200, the host computer provides the user data by executing a host application. In step 2204, the host computer initiates a transmission carrying the user data to the UE. In step 2206 (which may be optional), the base station transmits to the UE the user data which was carried in the transmission that the host computer initiated, in accordance with the teachings of the embodiments described throughout this disclosure. In step 2208 (which may also be optional), the UE executes a client application associated with the host application executed by the host computer.

FIG. 23 is a flowchart illustrating a method implemented in a communication system, in accordance with one embodiment. The communication system includes a host computer, a base station, and a UE which may be those described with reference to FIGS. 20 and 21. For simplicity of the present disclosure, only drawing references to FIG. 23 will be included in this section. In step 2300 of the method, the host computer provides user data. In an optional sub-step (not shown) the host computer provides the user data by executing a host application. In step 2302, the host computer initiates a transmission carrying the user data to the UE. The transmission may pass via the base station, in accordance with the teachings of the embodiments described throughout this disclosure. In step 2304 (which may be optional), the UE receives the user data carried in the transmission.

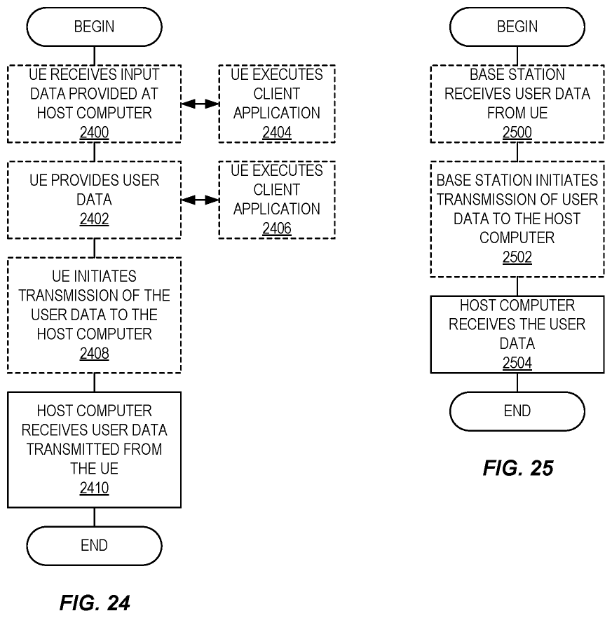

FIG. 24 is a flowchart illustrating a method implemented in a communication system, in accordance with one embodiment. The communication system includes a host computer, a base station, and a UE which may be those described with reference to FIGS. 20 and 21. For simplicity of the present disclosure, only drawing references to FIG. 24 will be included in this section. In step 2400 (which may be optional), the UE receives input data provided by the host computer. Additionally or alternatively, in step 2402, the UE provides user data. In sub-step 2404 (which may be optional) of step 2400, the UE provides the user data by executing a client application. In sub-step 2406 (which may be optional) of step 2402, the UE executes a client application which provides the user data in reaction to the received input data provided by the host computer. In providing the user data, the executed client application may further consider user input received from the user. Regardless of the specific manner in which the user data was provided, the UE initiates, in sub-step 2408 (which may be optional), transmission of the user data to the host computer. In step 2410 of the method, the host computer receives the user data transmitted from the UE, in accordance with the teachings of the embodiments described throughout this disclosure.

FIG. 25 is a flowchart illustrating a method implemented in a communication system, in accordance with one embodiment. The communication system includes a host computer, a base station, and a UE which may be those described with reference to FIGS. 20 and 21. For simplicity of the present disclosure, only drawing references to FIG. 25 will be included in this section. In step 2500 (which may be optional), in accordance with the teachings of the embodiments described throughout this disclosure, the base station receives user data from the UE. In step 2502 (which may be optional), the base station initiates transmission of the received user data to the host computer. In step 2504 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

### Group A Embodiments

Embodiment 1: A method performed by a User Equipment, UE, (312), the method comprising one or more of the following:
receiving (1402), from a network node (1400), first information that provides a Channel State Information Reference Signal, CSI-RS, configuration with a plurality of CSI-RS samples at different time instances;
receiving (1404), from the network node (1400), second information that configures the UE (312) to report Channel State Information, CSI, feedback based on the CSI-RS configuration with the plurality of CSI-RS samples at different times instances;
computing (1406) at least some aspect(s) of a precoding matrix for each CSI-RS sample of the plurality of CSI-RS samples, in accordance with the second information; and
reporting (1408), to the network node (1400), either the at least some aspect(s) of the precoding matrix for each CSI-RS sample of the plurality of CSI-RS samples or information derived therefrom, via one or more CSI-RS reports.

Embodiment 2: The method of embodiment 1 wherein the plurality of CSI-RS samples are at different time instances within a single timeslot or slot (also denoted as “timeslot/slot”).

Embodiment 3: The method of embodiment 1 wherein the plurality of CSI-RS samples are at different time instances, the different time instances comprising at least one time instance in a first timeslot/slot and at least one time instance in a second timeslot/slot that is different than the first timeslot/slot.

Embodiment 4: The method of any of embodiments 1 to 3 wherein the different times instances are (1) different Orthogonal Frequency Division Multiplexing, OFDM, symbols within a single timeslot/slot, or (2) same or different OFDM symbols in different timeslot/slot.

Embodiment 5: The method of any of embodiments 1 to 4 wherein the first information comprises information that configures the plurality of CSI-RS samples as different NZP CSI-RS resources in a NZP CSI-RS resource set.

Embodiment 6: The method of any of embodiments 1 to 4 wherein the first information comprises information that configures: a plurality NZP CSI-RS resources in a NZP CSI-RS resource set; and a parameter that indicates that the plurality of NZP CSI-RS resources in the NZP CSI-RS resource set are to be interpreted by the UE (312) as the plurality of CSI-RS samples of a same NZP CSI-RS.

Embodiment 7: The method of any of embodiments 5 to 6 wherein the first information further comprises information that explicitly or implicitly indicates a number of CSI-RS samples in the plurality of CSI-RS samples.

Embodiment 8: The method of any of embodiments 5 to 7 wherein CSI-RS resource mappings for at least some of the plurality of NZP CSI-RS resources in the NZP CSI-RS resource set are different.

Embodiment 9: The method of any of embodiments 5 to 8 wherein time-domain locations configured for at least some of the plurality of NZP CSI-RS resources in the NZP CSI-RS resource set are different.

Embodiment 10: The method of any of embodiments 5 to 9 wherein the first information further comprises one or more common parameters that are common to all of the plurality of NZP CSI-RS resources in the NZP CSI-RS resource set.

Embodiment 11: The method of any of embodiments 5 to 10 wherein all of the plurality of NZP CSI-RS resources in the NZP CSI-RS resource set have a same number of antenna ports.

Embodiment 12: The method of any of embodiments 5 to 10 wherein at least two of the plurality of NZP CSI-RS resources in the NZP CSI-RS resource set have different numbers of antenna ports.

Embodiment 13: The method of any of embodiments 5 to 10 wherein one NZP CSI-RS resource of the plurality of NZP CSI-RS resources in the NZP CSI-RS resource set has a first number of antenna ports and all remaining NZP CSI-RS resources of the plurality of NZP CSI-RS resources in the NZP CSI-RS resource set have a second number of antenna ports.

Embodiment 14: The method of embodiment 13 wherein the second number of antenna ports is less than the first number of antenna ports.

Embodiment 15: The method of embodiment 13 or 14 wherein the second number of antenna ports are associated with only a single polarization.

Embodiment 16: The method of any of embodiments 5 to 15 wherein the plurality of NZP-CSI resources in the NZP CSI-RS resource set are periodic, and a same TCI state ID is configured for all of the plurality of NZP-CSI resources in the NZP CSI-RS resource set.

Embodiment 17: The method of any of embodiments 5 to 15 wherein the plurality of NZP-CSI resources in the NZP CSI-RS resource set are periodic, and a single parameter that indicates a TCI state ID configured for one of the plurality of NZP-CSI resources in the NZP CSI-RS resource set and is applicable to all of the plurality of NZP-CSI resources in the NZP CSI-RS resource set.

Embodiment 18: The method of any of embodiments 5 to 15 wherein the plurality of NZP-CSI resources in the NZP CSI-RS resource set are periodic, and a single parameter that indicates a TCI state ID configured for all of the plurality of NZP-CSI resources in the NZP CSI-RS resource set is comprised in an information element that defines the NZP CSI-RS resource set.

Embodiment 19: The method of any of embodiments 5 to 15 wherein the plurality of NZP-CSI resources in the NZP CSI-RS resource set are semi-persistent, and a same TCI state ID is configured for all of the plurality of NZP-CSI resources in the NZP CSI-RS resource set via a MAC CE that activates the NZP CSI-RS resource set.

Embodiment 20: The method of any of embodiments 5 to 15 wherein the plurality of NZP-CSI resources in the NZP CSI-RS resource set are semi-persistent, and a single TCI state ID is configured and applicable to of the plurality of NZP-CSI resources in the NZP CSI-RS resource set via a MAC CE that activates the NZP CSI-RS resource set.

Embodiment 21: The method of any of embodiments 5 to 15 wherein the plurality of NZP-CSI resources in the NZP CSI-RS resource set are semi-persistent, and a single parameter that indicates a TCI state ID configured for all of the plurality of NZP-CSI resources in the NZP CSI-RS resource set is comprised in an information element that defines the NZP CSI-RS resource set.

Embodiment 22: The method of any of embodiments 5 to 15 wherein the plurality of NZP-CSI resources in the NZP CSI-RS resource set are aperiodic, and a same TCI state ID is configured for all of the plurality of NZP-CSI resources in the NZP CSI-RS resource set.

Embodiment 23: The method of any of embodiments 5 to 15 wherein the plurality of NZP-CSI resources in the NZP CSI-RS resource set are aperiodic, and a single TCI state ID is configured for all of the plurality of NZP-CSI resources in the NZP CSI-RS resource set via an information element that defines the NZP CSI-RS resource set

Embodiment 24: The method of any of embodiments 5 to 15 wherein a unified TCI state currently activated to the UE (312) is applied to all of the plurality of NZP-CSI resources in the NZP CSI-RS resource set.

Embodiment 25: The method of any of embodiments 1 to 4 wherein the first information comprises information that configures the plurality of CSI-RS samples via a configuration of a single NZP CSI-RS resource and information that defines a plurality of repetitions of the NZP CSI-RS resource which correspond to the plurality of CSI-RS samples.

Embodiment 26: The method of embodiment 25 wherein the information that defines the plurality of repetitions of the NZP CSI-RS resource comprises information indicates one or more time offsets or time gaps between repetitions of the NZP CSI-RS resource.

Embodiment 27: The method of embodiment 25 or 26 wherein the plurality of repetitions of the NZP CSI-RS resource are within a single timeslot/slot.

Embodiment 28: The method of embodiment 25 or 26 wherein at least one first repetition of the plurality of repetitions of the NZP CSI-RS resource is within a first timeslot/slot and at least one second repetition of the plurality of repetitions of the NZP

CSI-RS resource is within a second timeslot/slot.

Embodiment 29: The method of any of embodiments 1 to 28 wherein the CSI feedback is Type I CSI feedback, and, for each CSI-RS sample of the plurality of CSI-RS samples, the at least some aspect(s) of the precoding matrix reported to the network node comprises a set of cophasing coefficients (W₂).

Embodiment 30: The method of any of embodiments 1 to 28 wherein the CSI feedback is Type I CSI feedback, and:
for one CSI-RS sample of the plurality of CSI-RS samples, the at least some aspect(s) of the precoding matrix reported to the network node comprises a set of cophasing coefficient (W₂); and
for each remaining CSI-RS sample of the plurality of CSI-RS samples, the at least some aspect(s) of the precoding matrix reported to the network node comprises a phase difference of each coefficient of W₂ for the remaining CSI-RS sample and a respective coefficient of W₂ for the one CSI-RS sample.

Embodiment 31: The method of embodiments 29 or 30 wherein, for at least one CSI-RS sample of the plurality of CSI-RS samples, the at least some aspect(s) of the precoding matrix reported to the network node comprises a matrix (W₁) of size 2Nx2L that contains information of L selected DFT beams.

Embodiment 32: The method of any of embodiments 1 to 28 wherein the CSI feedback is Type II CSI feedback, and, for each CSI-RS sample of the plurality of CSI-RS samples, the at least some aspect(s) of the precoding matrix reported to the network node comprises a set of cophasing coefficient (W₂) and a selected set of FD bases vectors.

Embodiment 33: The method of any of embodiments 1 to 28 wherein the CSI feedback is Type II CSI feedback, and:
for one CSI-RS sample of the plurality of CSI-RS samples, the at least some aspect(s) of the precoding matrix reported to the network node comprises a set of cophasing coefficient (W₂) and a selected set of FD bases vectors; and
for each remaining CSI-RS sample of the plurality of CSI-RS samples, the at least some aspect(s) of the precoding matrix reported to the network node comprises a phase difference of each coefficient of W₂ for the remaining CSI-RS sample and a respective coefficient of W₂ for the one CSI-RS sample and a selected set of FD bases vectors.

Embodiment 34: The method of embodiments 32 or 33 wherein, for at least one CSI-RS sample of the plurality of CSI-RS samples, the at least some aspect(s) of the precoding matrix reported to the network node comprises a matrix (W₁) of size 2Nx2L that contains information of L selected DFT beams.

Embodiment 35: The method of any of the previous embodiments, further comprising: providing user data; and forwarding the user data to a host computer via the transmission to the base station.

### Group B Embodiments

Embodiment 36: A method performed by a network node (1400), the method comprising:
sending (1402), to a UE (312), first information that provides a Channel State Information Reference Signal, CSI-RS, configuration with a plurality of CSI-RS samples at different time instances;
sending (1404), to the UE (312), second information that configures the UE (312) to report Channel State Information, CSI, feedback based on the CSI-RS configuration with the plurality of CSI-RS samples at different times instances; and
receiving (1408), from the UE (312), either the at least some aspect(s) of the precoding matrix for each CSI-RS sample of the plurality of CSI-RS samples or information derived therefrom, via one or more CSI-RS reports.

Embodiment 37: The method of any of the previous embodiments, further comprising: obtaining user data; and forwarding the user data to a host computer or a wireless device.

### Group C Embodiments

Embodiment 38: A wireless device comprising:
processing circuitry configured to perform any of the steps of any of the Group A embodiments; and
power supply circuitry configured to supply power to the wireless device.

Embodiment 39: A base station comprising:
processing circuitry configured to perform any of the steps of any of the Group B embodiments; and
power supply circuitry configured to supply power to the base station.

Embodiment 40: A User Equipment, UE, comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

Embodiment 41: A communication system including a host computer comprising:
processing circuitry configured to provide user data; and
a communication interface configured to forward the user data to a cellular network for transmission to a User Equipment, UE;
wherein the cellular network comprises a base station having a radio interface and processing circuitry, the base station's processing circuitry configured to perform any of the steps of any of the Group B embodiments.

Embodiment 42: The communication system of the previous embodiment further including the base station.

Embodiment 43: The communication system of the previous 2 embodiments, further including the UE, wherein the UE is configured to communicate with the base station.

Embodiment 44: The communication system of the previous 3 embodiments, wherein:
the processing circuitry of the host computer is configured to execute a host application, thereby providing the user data; and
the UE comprises processing circuitry configured to execute a client application associated with the host application.

Embodiment 45: A method implemented in a communication system including a host computer, a base station, and a User Equipment, UE, the method comprising:
at the host computer, providing user data; and.
at the host computer, initiating a transmission carrying the user data to the UE via a cellular network comprising the base station, wherein the base station performs any of the steps of any of the Group B embodiments.

Embodiment 46: The method of the previous embodiment, further comprising, at the base station, transmitting the user data.

Embodiment 47: The method of the previous 2 embodiments, wherein the user data is provided at the host computer by executing a host application, the method further comprising, at the UE, executing a client application associated with the host application.

Embodiment 48: A User Equipment, UE, configured to communicate with a base station, the UE comprising a radio interface and processing circuitry configured to perform the method of the previous 3 embodiments.

Embodiment 49: A communication system including a host computer comprising:
processing circuitry configured to provide user data; and
a communication interface configured to forward user data to a cellular network for transmission to a User Equipment, UE;
wherein the UE comprises a radio interface and processing circuitry, the UE's components configured to perform any of the steps of any of the Group A embodiments.

Embodiment 50: The communication system of the previous embodiment, wherein the cellular network further includes a base station configured to communicate with the UE.

Embodiment 51: The communication system of the previous 2 embodiments, wherein:
the processing circuitry of the host computer is configured to execute a host application, thereby providing the user data; and
the UE's processing circuitry is configured to execute a client application associated with the host application.

Embodiment 52: A method implemented in a communication system including a host computer, a base station, and a User Equipment, UE, the method comprising:
at the host computer, providing user data; and
at the host computer, initiating a transmission carrying the user data to the UE via a cellular network comprising the base station, wherein the UE performs any of the steps of any of the Group A embodiments.

Embodiment 53: The method of the previous embodiment, further comprising at the UE, receiving the user data from the base station.

Embodiment 54: A communication system including a host computer comprising:
communication interface configured to receive user data originating from a transmission from a User Equipment, UE, to a base station;
wherein the UE comprises a radio interface and processing circuitry, the UE's processing circuitry configured to perform any of the steps of any of the Group A embodiments.

Embodiment 55: The communication system of the previous embodiment, further including the UE.

Embodiment 56: The communication system of the previous 2 embodiments, further including the base station, wherein the base station comprises a radio interface configured to communicate with the UE and a communication interface configured to forward to the host computer the user data carried by a transmission from the UE to the base station.

Embodiment 57: The communication system of the previous 3 embodiments, wherein:
the processing circuitry of the host computer is configured to execute a host application; and
the UE's processing circuitry is configured to execute a client application associated with the host application, thereby providing the user data.

Embodiment 58: The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.

Embodiment 59: A method implemented in a communication system including a host computer, a base station, and a User Equipment, UE, the method comprising: at the host computer, receiving user data transmitted to the base station from the UE, wherein the UE performs any of the steps of any of the Group A embodiments.

Embodiment 60: The method of the previous embodiment, further comprising, at the UE, providing the user data to the base station.

Embodiment 61: The method of the previous 2 embodiments, further comprising:
at the UE, executing a client application, thereby providing the user data to be transmitted; and
at the host computer, executing a host application associated with the client application.

Embodiment 62: The method of the previous 3 embodiments, further comprising:
at the UE, executing a client application; and
at the UE, receiving input data to the client application, the input data being provided at the host computer by executing a host application associated with the client application;
wherein the user data to be transmitted is provided by the client application in response to the input data.

Embodiment 63: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Group B embodiments.

Embodiment 64: The communication system of the previous embodiment further including the base station.

Embodiment 65: The communication system of the previous 2 embodiments, further including the UE, wherein the UE is configured to communicate with the base station.

Embodiment 66: The communication system of the previous 3 embodiments, wherein:
the processing circuitry of the host computer is configured to execute a host application; and
the UE is configured to execute a client application associated with the host application, thereby providing the user data to be received by the host computer.

Embodiment 67: A method implemented in a communication system including a host computer, a base station, and a User Equipment, UE, the method comprising: at the host computer, receiving, from the base station, user data originating from a transmission which the base station has received from the UE, wherein the UE performs any of the steps of any of the Group A embodiments.

Embodiment 68: The method of the previous embodiment, further comprising at the base station, receiving the user data from the UE.

Embodiment 69: The method of the previous 2 embodiments, further comprising at the base station, initiating a transmission of the received user data to the host computer.

Those skilled in the art will recognize improvements and modifications to the embodiments of the present disclosure. All such improvements and modifications are considered within the scope of the concepts disclosed herein.

1. A method performed by a User Equipment, UE, the method comprising:
receiving, from a network node, first information that provides a Channel State Information Reference Signal, CSI-RS, configuration with a plurality of CSI-RS samples at different time instances, wherein the plurality of CSI-RS samples are aperiodic, wherein the plurality of CSI-RS samples are triggered by a single trigger;
receiving, from the network node, second information that configures the UE to report Channel State Information, CSI, feedback based on the CSI-RS configuration with the plurality of CSI-RS samples;
computing at least one or more aspects of a precoding matrix for each CSI-RS sample of the plurality of CSI-RS samples, in accordance with the second information; and
reporting, to the network node, either the at least one or more aspects of the precoding matrix for each CSI-RS sample of the plurality of CSI-RS samples or information derived therefrom, via one or more CSI-RS reports.

2. The method of claim 1 wherein the plurality of CSI-RS samples are at different time instances within a single timeslot.

3. The method of claim 1 wherein the plurality of CSI-RS samples are at different time instances, the different time instances comprise at least one time instance in a first timeslot and at least one time instance in a second timeslot that is different than the first timeslot.

4. The method of claim 1 wherein the different times instances are either: different Orthogonal Frequency Division Multiplexing, OFDM, symbols within a single timeslot, or a same OFDM symbol in different timeslots, or different OFDM symbols in different timeslots.

5. The method of claim 1 wherein the first information comprises information that configures the plurality of CSI-RS samples as different Non-Zero Power, NZP, CSI-RS resources in a NZP CSI-RS resource set.

6. The method of claim 1 wherein the first information comprises information that configures:
a plurality Non-Zero Power, NZP, CSI-RS resources in a NZP CSI-RS resource set; and
a parameter that indicates that the plurality of NZP CSI-RS resources in the NZP CSI-RS resource set are to be interpreted by the UE (312) as the plurality of CSI-RS samples of a same NZP CSI-RS.

7. (canceled)

8. (canceled)

9. The method of claim 5 wherein the number of CSI-RS samples in the plurality of CSI-RS samples is equal to the number of NZP CSI-RS resources in the NZP CSI-RS resource set.

10. The method of claim 5 wherein the first information further comprises information that explicitly or implicitly indicates a number of CSI-RS samples in the plurality of CSI-RS samples.

11. (canceled)

12. The method of claim 5 wherein time-domain locations configured for at least some of the plurality of NZP CSI-RS resources in the NZP CSI-RS resource set are different.

13. The method of claim 5 wherein the first information further comprises one or more common parameters that are common to all of the plurality of NZP CSI-RS resources in the NZP CSI-RS resource set.

14. The method of claim 5 wherein all of the plurality of NZP CSI-RS resources in the NZP CSI-RS resource set have a same number M of antenna ports.

15. The method of claim 14, wherein the m^{th} (m=0,1, . . . , M−1) antenna port for all of the plurality of NZP CSI-RS resources in the NZP CSI-RS resource set is the same.

16-25. (canceled)

26. The method of claim 5 wherein the plurality of NZP CSI resources in the NZP CSI-RS resource set are aperiodic, and a same Transmission Configuration Indication, TCI, state identity, ID, is configured for all of the plurality of NZP CSI resources in the NZP CSI-RS resource set.

27. The method of claim 5 wherein the plurality of NZP CSI resources in the NZP CSI-RS resource set are aperiodic, and a single Transmission Configuration Indication, TCI, state identity, ID, is configured for all of the plurality of NZ-CSI resources in the NZP CSI-RS resource set via an information element that defines the NZP CSI-RS resource set.

28. The method of claim 5 wherein a unified Transmission Configuration Indication, TCI, state currently activated to the UE (312) is applied to all of the plurality of NZP CSI resources in the NZP CSI-RS resource set.

29-32. (canceled)

33. The method of claim 1 wherein the CSI feedback is Type I CSI feedback, and, for each CSI-RS sample of the plurality of CSI-RS samples, the at least one or more aspects of the precoding matrix reported to the network node comprises a set of cophasing coefficients (W₂).

34. The method of claim 1 wherein the CSI feedback is Type I CSI feedback, and:
for one CSI-RS sample of the plurality of CSI-RS samples, the at least one or more aspects of the precoding matrix reported to the network node comprises a set of cophasing coefficient (W₂); and
for each remaining CSI-RS sample of the plurality of CSI-RS samples, the at least one or more aspects of the precoding matrix reported to the network node comprises a phase difference of each coefficient of W₂ for the remaining CSI-RS sample and a respective coefficient of W₂ for the one CSI-RS sample.

35. The method of claim 33 wherein, for at least one CSI-RS sample of the plurality of CSI-RS samples, the at least one or more aspects of the precoding matrix reported to the network node comprises a matrix (W₁) that contains information of one or more selected Discrete Fourier Transform, DFT, beams.

36. The method of claim 1 wherein the CSI feedback is Type II CSI feedback, and, for each CSI-RS sample of the plurality of CSI-RS samples, the at least one or more aspects of the precoding matrix reported to the network node comprises a set of cophasing coefficient (W₂) and a selected set of Frequency Domain, FD, basis vectors.

37. The method of claim 1 wherein the CSI feedback is Type II CSI feedback, and:
for one CSI-RS sample of the plurality of CSI-RS samples, the at least one or more aspects of the precoding matrix reported to the network node comprises a set of cophasing coefficient (W₂) and a selected set of Frequency Domain, FD, basis vectors; and
for each remaining CSI-RS sample of the plurality of CSI-RS samples, the at least one or more aspects of the precoding matrix reported to the network node comprises a phase difference of each coefficient of W₂ for the remaining CSI-RS sample and a respective coefficient of W₂ for the one CSI-RS sample and a selected set of Frequency Domain, FD, basis vectors.

38. The method of claim 36 wherein, for at least one CSI-RS sample of the plurality of CSI-RS samples, the at least one or more aspects of the precoding matrix reported to the network node comprises a matrix (W₁) that contains information of one or more selected Discrete Fourier Transform, DFT, beams.

39. (canceled)

40. A User Equipment, UE, comprising:
one or more transmitters;
one or more receivers; and
processing circuitry associated with the one or more transmitters and the one or more receivers, the processing circuitry configured to cause the UE to:
receive, from a network node, first information that provides a Channel State Information Reference Signal, CSI-RS, configuration with a plurality of CSI-RS samples at different time instances, wherein the plurality of CSI-RS samples are aperiodic, wherein the plurality of CSI-RS samples are triggered by a single trigger;
receive, from the network node, second information that configures the UE to report Channel State Information, CSI, feedback based on the CSI-RS configuration with the plurality of CSI-RS samples;
compute at least one or more aspects of a precoding matrix for each CSI-RS sample of the plurality of CSI-RS samples, in accordance with the second information; and
report, to the network node, either the at least one or more aspects of the precoding matrix for each CSI-RS sample of the plurality of CSI-RS samples or information derived therefrom, via one or more CSI-RS reports.

41. (canceled)

42. A method performed by a network node, the method comprising:
sending, to a UE, first information that provides a Channel State Information Reference Signal, CSI-RS, configuration with a plurality of CSI-RS samples at different time instances, wherein the plurality of CSI-RS samples are aperiodic, wherein the plurality of CSI-RS samples are triggered by a single trigger;
sending, to the UE, second information that configures the UE to report Channel State Information, CSI, feedback based on the CSI-RS configuration with the plurality of CSI-RS samples at different times instances; and
receiving, from the UE, either at least one or more aspects of the precoding matrix for each CSI-RS sample of the plurality of CSI-RS samples or information derived therefrom, via one or more CSI-RS reports.

43-49. (canceled)

50. A network node comprising processing circuitry configured to cause the network node to:
send, to a UE, first information that provides a Channel State Information Reference Signal, CSI-RS, configuration with a plurality of CSI-RS samples at different time instances, wherein the plurality of CSI-RS samples are aperiodic, wherein the plurality of CSI-RS samples are triggered by a single trigger;
send, to the UE, second information that configures the UE to report Channel State Information, CSI, feedback based on the CSI-RS configuration with the plurality of CSI-RS samples at different times instances; and
receive, from the UE, either at least one or more aspects of the precoding matrix for each CSI-RS sample of the plurality of CSI-RS samples or information derived therefrom, via one or more CSI-RS reports.

51. (canceled)
